(19) United States
(12) Patent Application Publication
(10) Pub. No.: US 2016/0163013 A1
(43) Pub. Date: Jun. 9, 2016

(54) DATA PROCESSING SYSTEM AND DATA PROCESSING METHOD

(71) Applicant: Masaki ARAI, Tokyo (JP)

(72) Inventor: Masaki ARAI, Tokyo (JP)

(73) Assignee: RICOH COMPANY, LTD., Tokyo (JP)

(21) Appl. No.: 14/953,555

(22) Filed: Nov. 30, 2015

(30) Foreign Application Priority Data
Dec. 3, 2014 (JP) 2014-244734

(51) Int. Cl. G06T 1/00; G06F 3/14; H04L 29/08; G06F 3/0484

(52) U.S. Cl. CPC G06T 1/0007; G06F 3/04842; G06F 3/1423; H04L 67/10

(57) ABSTRACT

A data processing system includes a notification unit that notifies data regarding an image that is input or output by an electronic device to terminal devices that are in the same group as the electronic device while the data regarding the image is under a viewable state among the terminal devices; a history data storing unit that stores information of electronic data of the image in association with the data regarding the image selected at the respective terminal device; and a management unit that provides the electronic data of the image to the respective terminal device based on the information of the electronic data of the image stored in the history data storing unit in association with the data regarding the image selected at the respective terminal device after the viewable state is finished.

### BACKGROUND OF THE INVENTION

1. Field of the Invention

The present invention relates to a data processing system and a data processing method.

2. Description of the Related Art

Recently, in conferences, not only paper documents, but also electronic files displayed by an image display device such as a projector or displayed on an electronic blackboard (interactive white board) are used.

Conventionally, an electronic conference system is known that electronically assists knowledge creating conferences. The conventional electronic conference system has a function to share data provided by each participant to a public place to all of the participants by delivering the data to a handy terminal device of each of the participants or to a common screen capable of being viewed by all of the participants (see Patent Document 1, for example).

For example, in a data processing system such as the electronic conference system, the participants can view data when a speaker outputs data of a document to an electronic device. In such a data processing system, when a participant wants to obtain the data that is displayed on a screen or the like, the participant needs to ask the speaker for the data.

Thus, if the participant asks the speaker for the data, the speaker needs to prepare the data to provide it to the participant. It is troublesome for the speaker to prepare the required data (select a page sheet or the like of the data to be provided from a file, and process the file, for example) and to provide the data (operate to send the file, for example).

### Patent Document

### [Patent Document 1] Japanese Patent No. 4,053,378

### SUMMARY OF THE INVENTION

The present invention is made in light of the above problems, and provides a data processing system by which data that is under a viewable state among a plurality of users can be easily provided after the viewable state is finished.

According to an embodiment, there is provided a data processing system including at least a data processing apparatus further including a group data storing unit that stores a plurality of terminal devices and an electronic device that performs at least one of inputting and outputting of an image, as a group; a notification unit that notifies data regarding an image that is input or output by the electronic device to the terminal devices that are in the same group as the electronic device while the data regarding the image is under a viewable state among the terminal devices; a history data storing unit that stores, for each of the terminal devices, information of electronic data of the image in association with the data regarding the image selected at the respective terminal device among the data regarding the image notified to the terminal device; and a management unit that provides, for each of the terminal devices, the electronic data of the image to the respective terminal device based on the information of the electronic data of the image stored in the history data storing unit in association with the data regarding the image selected at the respective terminal device after the viewable state is finished.

Note that also arbitrary combinations of the above-described elements, and any changes of expressions in the present invention, made among methods, devices, systems, recording media, computer programs and so forth, are valid as embodiments of the present invention.

### BRIEF DESCRIPTION OF THE DRAWINGS

Other objects, features and advantages of the present invention will become more apparent from the following detailed description when read in conjunction with the accompanying drawings.

FIG. 1 is a view illustrating an example of a structure of a conference system of an embodiment;

FIG. 2 is a view illustrating an example of a hardware structure of a computer of the embodiment;

FIG. 3 is a view illustrating an example of a hardware structure of a terminal device of the embodiment;

FIG. 4 is a view illustrating an example of a hardware structure of a projector of the embodiment;

FIG. 5 is a block diagram illustrating an example of a functional structure of the conference system of the embodiment;

FIG. 6 is a timing chart illustrating an example of an overview of a use case;

FIG. 7 is a flowchart illustrating an example of a log-in process to a conference room group;

FIG. 8 is an image view illustrating an example of a group list screen;

FIG. 9 is an image view illustrating an example of a NFC touch request screen;

FIG. 10 is an image view illustrating an example of the group list screen after being logged in;

FIG. 11 is an image view illustrating an example of a conference status screen including a time line screen;

FIG. 12 is a view illustrating an example of a structure of a group list stored in a data storing unit;

FIG. 13 is a view illustrating an example of a structure of a member list stored in the data storing unit;

FIG. 14 is a sequence diagram illustrating an example of a process of using the projector;

FIG. 15 is an image view illustrating an example of the conference status screen including a file selection button;

FIG. 16 is an image view illustrating an example of a file list screen;

FIG. 17 is an image view illustrating an example of a device list screen;

FIG. 18 is an image view illustrating an example of the conference status screen when starting projection by the projector;

FIG. 19 is an image view illustrating an example of the conference status screen after turning a page;

FIG. 20 is a view illustrating an example of a structure of a message history;

FIG. 21 is a flowchart illustrating an example of a process of using an IWB;

FIG. 22 is an image view illustrating an example of the conference status screen after using the IWB;

FIG. 23 is a flowchart illustrating another example of the process of using the IWB;

FIG. 24 is a flowchart illustrating an example of a process of using a MFP;

FIG. 25 is an image view illustrating an example of the conference status screen after scanning;

FIG. 26 is a sequence diagram illustrating an example of a log-out process from the conference room group;

FIG. 27 is an image view illustrating an example of the group list screen after being logged out;

FIG. 28 is a sequence diagram for explaining a function of prohibiting an acquisition of a file;

FIG. 29 is an image view illustrating an example of a prohibition of acquisition button of the conference status screen; and

FIG. 30 is a view illustrating another example of a structure of the message history.

### DETAILED DESCRIPTION OF THE PREFERRED EMBODIMENTS

The invention will be described herein with reference to illustrative embodiments. Those skilled in the art will recognize that many alternative embodiments can be accomplished using the teachings of the present invention and that the invention is not limited to the embodiments illustrated for explanatory purposes. It is to be noted that, in the explanation of the drawings, the same components are given the same reference numerals, and explanations are not repeated.

The conference system 1 of the embodiment is an example of a data processing system.

### First Embodiment

### (System Structure)

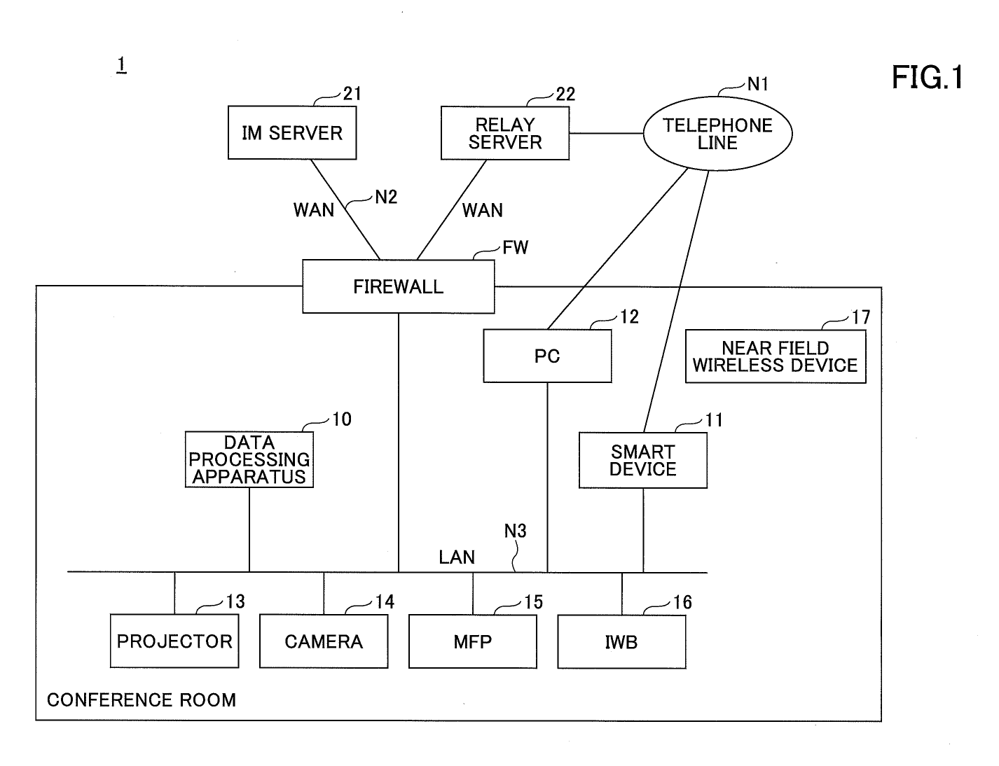

FIG. 1 is a view illustrating an example of a structure of the conference system 1 of the embodiment. The conference system 1 illustrated in FIG. 1 includes a data processing apparatus 10, a smart device 11, a PC 12, a projector 13, a camera 14, a MFP (multifunction peripheral) 15, an IWB (electronic white board) 16 and a near field wireless device 17 in a conference room.

In the conference system 1 of FIG. 1, the data processing apparatus 10, the smart device 11, the PC 12, the projector 13, the camera 14, the MFP 15 and the IWB 16 are connected with each other via a network N3 such as LAN or the like. Further, the near field wireless device (NFC) 17 is provided in the conference room.

The network N3 is connected to an instant messaging (IM) server 21 and a relay server 22 via a firewall FW and a network N2 such as the INTERNET or WAN (wide area network). Further, the smart device 11 and the PC 12 are capable of being connected to the relay server 22 via a network N1 such as a telephone line.

The projector 13, the camera 14, the MFP 15 and the IWB 16 provided in the conference system 1 of FIG. 1 are an example of an electronic device that performs at least one of inputting and outputting of an image inputs and outputs data. Further, the conference system 1 of FIG. 1 may include a plurality of each of the projector 13, the camera 14, the MFP 15 and the IWB 16.

The data processing apparatus 10 has a function of a file server. Further, the data processing apparatus 10 inputs and outputs a file in accordance with a request. Further, the data processing apparatus 10 has a function to convert a format of a file. Further, the data processing apparatus 10 manages a group of an instant messaging (IM) and stores a message history. The data processing apparatus 10 may be structured to be distributed in a plurality of computers.

The smart device 11 is an example of a terminal device operated by a user, and is a tablet terminal, a smartphone, a mobile phone or the like. The smart device 11 is capable of being connected to the networks N1 and N3. The network N1 is capable of using a telephone line such as a 3G network.

The smart device 11 is capable of being connected to the data processing apparatus 10 via the network N1 and the relay server 22. Further, the smart device 11 is capable of being connected to the data processing apparatus 10 via the network N3. Further, the smart device 11 may request the data processing apparatus 10 to operate a file. Further, the smart device 11 becomes a client of the instant messaging, and is capable of sending and receiving a message. Further, the smart device 11 has a function to send and receive data with the near field wireless device 17.

The PC 12 is also an example of the terminal device operated by a user. The PC 12 is capable of being connected to the networks N1 and N3. The PC 12 is capable of being connected to the data processing apparatus 10 via the network N1 and the relay server 22. Further, the PC 12 is capable of being connected to the data processing apparatus 10 via the network N3. The PC 12 may request the data processing apparatus 10 to operate a file.

Further, the PC 12 becomes a client of the instant messaging, and is capable of sending and receiving a message. Further, the PC 12 has a function to send and receive data with the near field wireless device 17.

The projector 13 is capable of being connected to the data processing apparatus 10 via the network N3. The projector 13 is capable of projecting and displaying a file stored in the data processing apparatus 10. The projector 13 is an example of an image projection apparatus.

The camera 14 has a function to store a static image and a moving image. The camera 14 is capable of being connected to the data processing apparatus 10 via the network N3. The camera 14 stores the static image and the moving image in the data processing apparatus 10. The camera 14 is an example of an image photographing apparatus.

The MFP 15 is an input and output device in which a copy function, a facsimile (FAX) function, a print function, a scanner function, a delivering function of an input image (a document image read by the scanner function or an image input by the print function or the facsimile function) and the like are combined. The MFP 15 is an example of an image forming apparatus.

The IWB 16 has a function of an electronic white board. The IWB 16 is capable of being connected to the data processing apparatus 10 via the network N3. The IWB 16 is capable of projecting and displaying a file stored in the data processing apparatus 10. Further, the IWB 16 has a function to output input characters or graphics as a new file. The IWB 16 is an example of an input and output device capable of inputting and outputting an image.

The near field wireless device 17 provides data to the smart device 11 and the PC 12 using near field wireless communication such as Bluetooth (registered trademark) or NFC (Near Field Communication).

The IM server 21 has a function to receive a message content or the like for performing an instant messaging function between the smart devices 11 and the PC 12, and deliver the message content to members of the group. The relay server 22 has a function to use the data processing apparatus 10, the projector 13, the camera 14, the MFP 15 and the IWB 16 from a network N2 side by relaying the connection from the smart device 11 or the PC 12.

Here, the structure of the conference system 1 of FIG. 1 is just an example, and the structure of the conference system 1 is not limited to that illustrated in FIG. 1. For example, the data processing apparatus 10, the IM server 21 and the relay server 22 may be configured by a single computer. As such, the classification of the data processing apparatus 10, the IM server 21 and the relay server 22 of the conference system 1 of FIG. 1 is just an example.

### (Hardware Structure)

### (Computer)

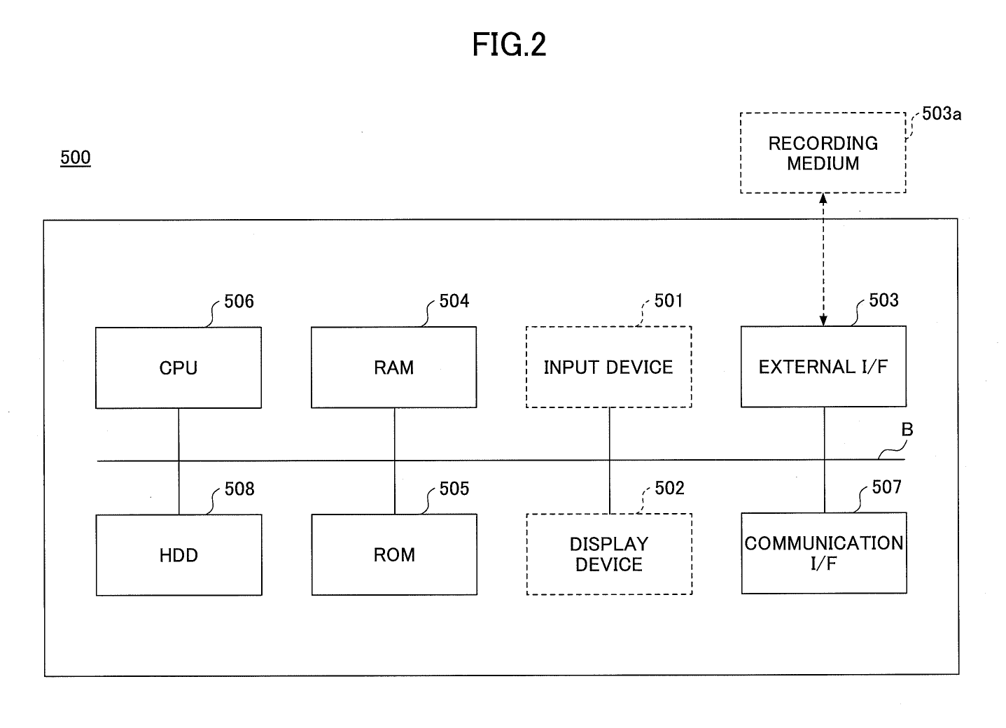

Each of the data processing apparatus 10, the PC 12, the IM server 21 and the relay server 22 may be actualized by a computer having a hardware structure as illustrated in FIG. 2, for example. FIG. 2 is a view illustrating an example of a hardware structure of a computer 300 of the embodiment.

The computer 500 of FIG. 2 includes an input device 501, a display device 502, an external I/F 503, a RAM 504, a ROM 505, a CPU 506, a communication I/F 507, a HDD 508 and the like, which are connected with each other by a bus B. The input device 501 and the display device 502 may be connected only when it is necessary.

The input device 501 includes a keyboard, a mouse, a touch panel or the like, and is used by a user to input various operation signals. The display device 502 includes a display or the like and displays a processed result by the computer 500.

The communication I/F 507 is an interface for connecting the computer 500 to various networks. With this configuration, the computer 500 is capable of performing data communication via the communication I/F 507.

Further, the HDD 508 is an example of a non-volatile storage device that stores programs and data. The programs and data stored in the HDD 508 include an OS that is basic software for controlling the entirety of the computer 500, application program software that provides various functions on the OS (hereinafter, simply referred to as an “application program”) or the like, for example. Here, the computer 500 may include a drive device that uses a flash memory as a storage medium (Solid State Drive (SSD), for example) instead of the HDD 508.

The external I/F 503 is an interface for an external device. As the external device, a recording medium 503a or the like may be raised. With this configuration, the computer 500 is capable of reading and/or writing data from and to the recording medium 503a via the external I/F 503. As the recording medium 503a, a flexible disk, a Compact Disk (CD), a Digital Versatile Disk (DVD), an SD Memory card, a Universal Serial Bus memory (USB memory) or the like may be raised.

The ROM 505 is an example of a non-volatile semiconductor memory (storage device) that can store programs and data even when the switch is turned off. The ROM 505 stores programs and data such as a Basic Input/Output System (BIOS) that is executed when activating the computer 500, an OS setting, a network setting. The RAM 504 is an example of a volatile semiconductor memory (storage device) that temporarily stores programs and data.

The CPU 506 is an arithmetic unit that actualizes control and functions of the entirety of the computer 500 by reading out programs or data from the storage device such as the ROM 505 or the HDD 508 on the RAM 504 and executing the processes.

Each of the data processing apparatus 10, the PC 12, the IM server 21 and the relay server 22 may actualize various processes, which will be explained later, by the hardware structure of the computer 500 illustrated in FIG. 2, for example.

### (Terminal Device)

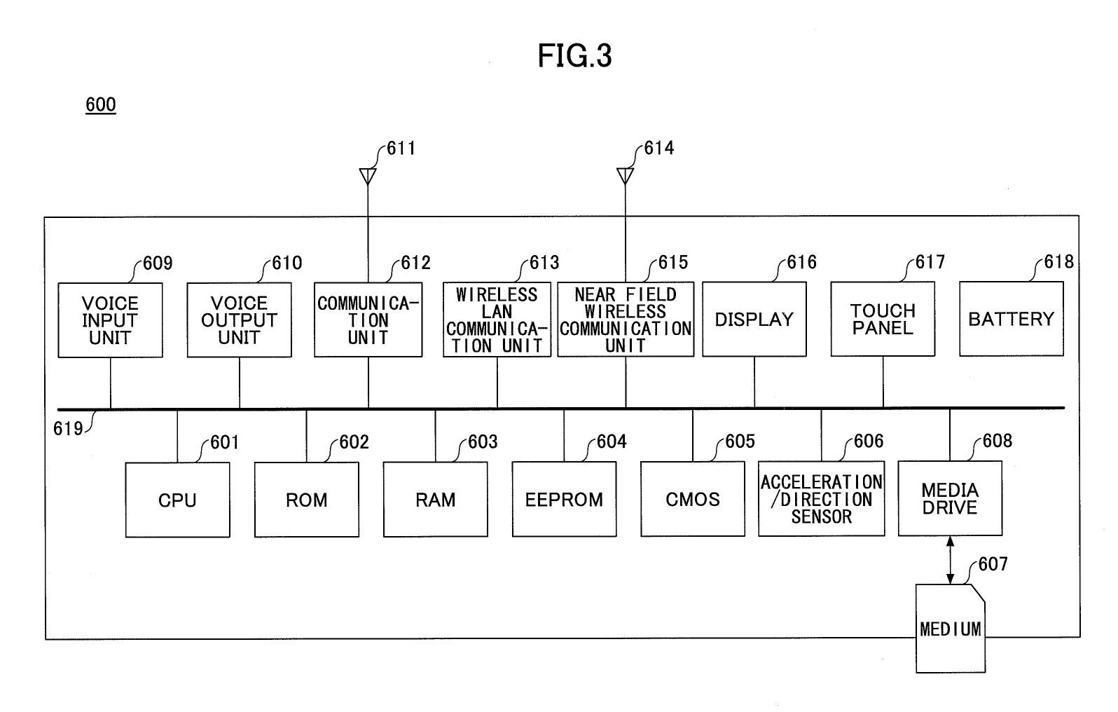

The smart device 11 is actualized by a terminal device having a hardware structure as illustrated in FIG. 3. FIG. 3 is a view illustrating an example of a hardware structure of a terminal device 600 of the embodiment. The terminal device 600 of FIG. 3 includes a CPU 601, a ROM 602, a RAM 603, an EEPROM 604, a CMOS sensor 605, an acceleration/direction sensor 606 and a media drive 608, for example.

The CPU 601 controls the entirety of the terminal device 600. The ROM 602 stores a basic input/output program. The RAM 603 is used as a work area of the CPU 601. The EEPROM 604 reads data out and write data on in accordance with the control of the CPU 601. The CMOS sensor 605 obtains a picture of an object to obtain image data in accordance with the control of the CPU 601. The acceleration/direction sensor 606 is an electronic magnetic compass that detects geomagnetism, a gyro compass, an acceleration sensor or the like.

The media drive 608 controls reading and writing (storing) of data from and on a recording medium 607 such as a flash memory. The media drive 608 is configured such that the recording medium 607 is detachably attached thereto from which previously stored data is read out and on which new data is written.

Here, the EEPROM 604 stores an OS executed by the CPU 601, association data necessary for network setting or the like. An application program for performing various processes of the embodiment is stored in the EEPROM 604, the recording medium 607 or the like.

Further, the CMOS sensor 605 is a charge coupled device that converts light to electric charges to obtain electronic data of an image of an object. The CMOS sensor 605 may be a CCD (Charge Coupled Device), for example, as long as it can obtain an image of an object.

Further, the terminal device 600 includes a voice input unit 609, a voice output unit 610, an antenna 611, a communication unit 612, a wireless LAN communication unit 613, an antenna for a near field wireless communication 614, a near field wireless communication unit 615, a display 616, a touch panel 617 and a bus line 619.

The voice input unit 609 converts voice to a voice signal. The voice output unit 610 converts a voice signal to voice. The communication unit 612 communicates with a nearest base station apparatus by a wireless communication signal using the antenna 611. The wireless LAN communication unit 613 performs wireless LAN communication with an access point conforming to an IEEE 80411 standard. The near field wireless communication unit 615 performs near field wireless communication using the antenna for a near field wireless communication 614.

The display 616 is a liquid crystal, an organic EL or the like that displays an image of an object, various icons or the like. The touch panel 617 is mounted on the display 616, configured by a pressure-sensitive or electrostatic panel, and detects a touched position of touching on the display 616 by a finger, a touch pen or the like. The bus line 619 is an address bus, a data bus or the like for electrically connecting the above described parts.

Further, the terminal device 600 includes a battery 618. The terminal device 600 is activated by the battery 618. The voice input unit 609 includes a microphone that inputs voice. The voice output unit 610 includes a speaker that outputs voice.

The smart device 11 may actualize various processes, which will be explained later, by the hardware structure of the terminal device 600 as illustrated in FIG. 3, for example.

### (Electronic Device)

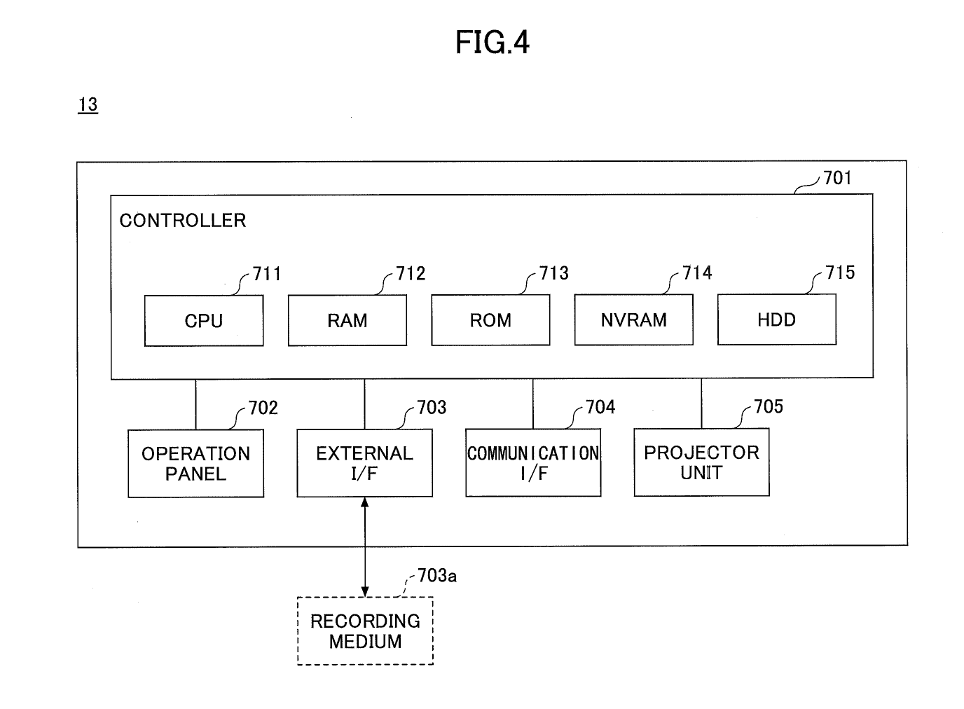

Here, among the projector 13, the camera 14, the MFP 15 and the IWB 16 of FIG. 1, which are an example of an electronic device, a hardware structure of the projector 13 is explained as an example. The projector 13 of FIG. 1 is actualized by a computer having a hardware structure as illustrated in FIG. 4, for example.

FIG. 4 is a view illustrating an example of a hardware structure of the projector 13 of the embodiment. The projector 13 of FIG. 4 includes a controller 701, an operation panel 702, an external I/F 703, a communication I/F 704, a projector unit 705 and the like.

The controller 701 includes a CPU 711, a RAM 712, a ROM 713, an NVRAM 714, a HDD 715 and the like. The ROM 713 stores various programs and data. The RAM 712 temporarily stores programs and data. The NVRAM 714 stores setting data or the like, for example. Further, the HDD 715 stores various programs and data.

The CPU 711 actualizes the control or the functions of the entirety of the projector 13 by reading out programs and data, setting data or the like from the ROM 713, the NVRAM 714, the HDD 715 or the like on the RAM 712 and executing the processes.

The operation panel 702 includes an input unit that accepts an input from a user and a display unit that displays data. The external I/F 703 is an interface for an external device. As the external device, a recording medium 703a or the like may be raised. With this configuration, the projector 13 is capable of reading and/or writing data from and to the recording medium 703a via the external I/F 703. As the recording medium 703a, an IC card, a flexible disk, a CD, a DVD, an SD memory card, a USB memory or the like may be raised.

The communication I/F 704 is an interface for connecting the projector 13 to the network N3. With this configuration, the projector 13 is capable of performing data communication via the communication I/F 704. The projector unit 705 projects a file.

The projector 13 can actualize the various processes, which will be explained later, by the hardware structure as illustrated in FIG. 4, for example.

### (Software Structure)

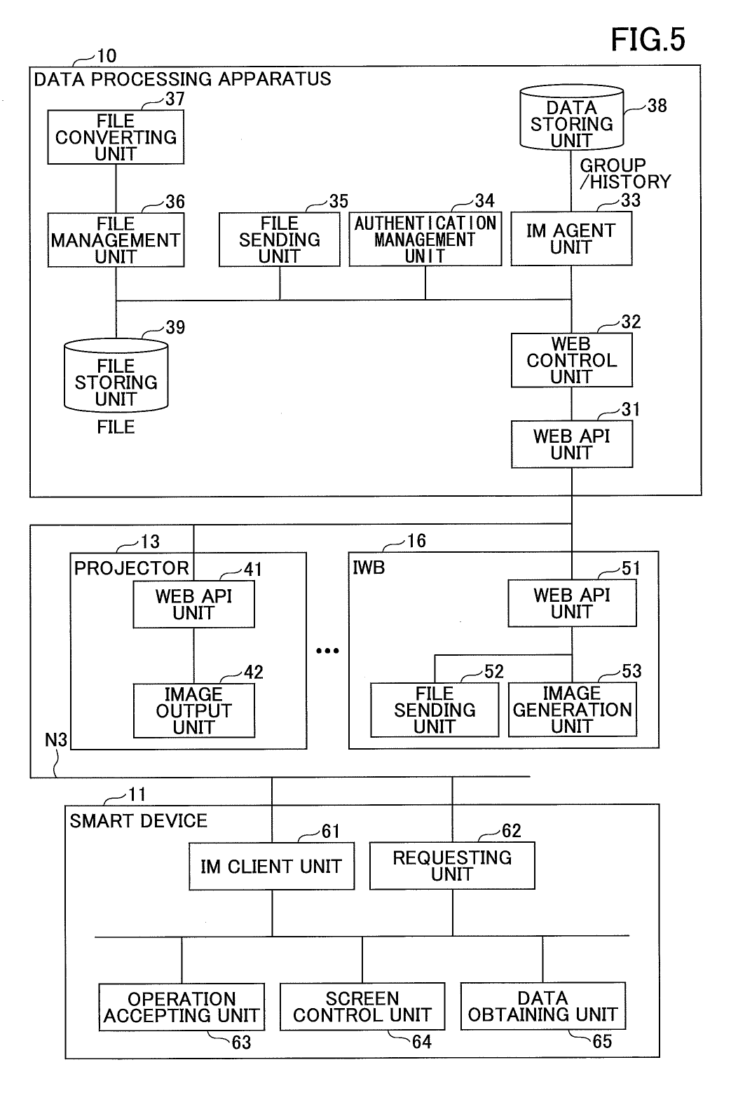

The conference system 1 of the embodiment is actualized by process blocks as illustrated in FIG. 5, for example. FIG. 5 is a block diagram illustrating an example of a functional structure of the conference system 1 of the embodiment. Here, the conference system 1 of FIG. 5 corresponds to a part of the structure illustrated in FIG. 1. For example, although in the conference system 1 of FIG. 5, it is described that the smart device 11 uses the data processing apparatus 10 or the electronic device such as the projector 13 via the network N3, the network N1 and the relay server 22 may be used. Further, the smart device 11 of FIG. 5 may be the PC 12.

The data processing apparatus 10 actualizes a Web API unit 31, a Web control unit 32, an IM agent unit 33, an authentication management unit 34, a file sending unit 35, a file management unit 36, a file converting unit 37, a data storing unit 38 and a file storing unit 39 by executing a program.

The Web API unit 31 is a Web application programming interface and accepts a request to the data processing apparatus 10. The Web control unit 32 interprets the request accepted by the Web API unit 31 and sends a request to each module in the data processing apparatus 10.

The IM agent unit 33 manages groups of an instant messaging and messages. The authentication management unit 34 authenticates whether the smart device 11 is a device that is registered in the data processing apparatus 10.

The file sending unit 35 sends a file to the electronic device such as the projector 13, or the smart device 11. The file management unit 36 manages the file stored in the data processing apparatus 10. Further, the file management unit 36 requests to convert a file to the file converting unit 37 as nessesary. Upon receiving the request to convert the file, the file converting unit 37 converts the file. Further, the data storing unit 38 stores a group list, a member list, a message history or the like, which will be explained layer. The file storing unit 39 stores the file.

The projector 13 actualizes a Web API unit 41 and an image output unit 42 by executing a program. The Web API unit 41 accepts a request to the projector 13. The image output unit 42 projects an input file (image).

The IWB 16 actualizes a Web API unit 51, a file sending unit 52 and a image generation unit 53 by executing a program. The Web API unit 51 accepts a request to the IWB 16. The file sending unit 52 sends a file generated by the image generation unit 53. The image generation unit 53 generates a file of characters, graphics or the like input by a user.

The smart device 11 actualizes an IM client unit 61, a requesting unit 62, an operation accepting unit 63, a screen control unit 64 and a data obtaining unit 65 by executing an application program. The IM client unit 61 functions as a client of an instant messaging, and sends and receives a message.

The requesting unit 62 requests to perform various processes to the electronic device such as the projector 13, or the data processing apparatus 10. The operation accepting unit 63 accepts an operation from the user. The screen control unit 64 controls a screen to be displayed on the display 616. The data obtaining unit 65 obtains data from the near field wireless device 17.

For example, the requesting unit 62 sends a request to output a file to the electronic device such as the projector 13. Further, the requesting unit 62 sends a request to obtain a file to the electronic device such as the IWB 16, or the data processing apparatus 10.

### (Detail of Process)

In the following, a process of the conference system 1 of the embodiment is described in detail.

### (Overview of use Case)

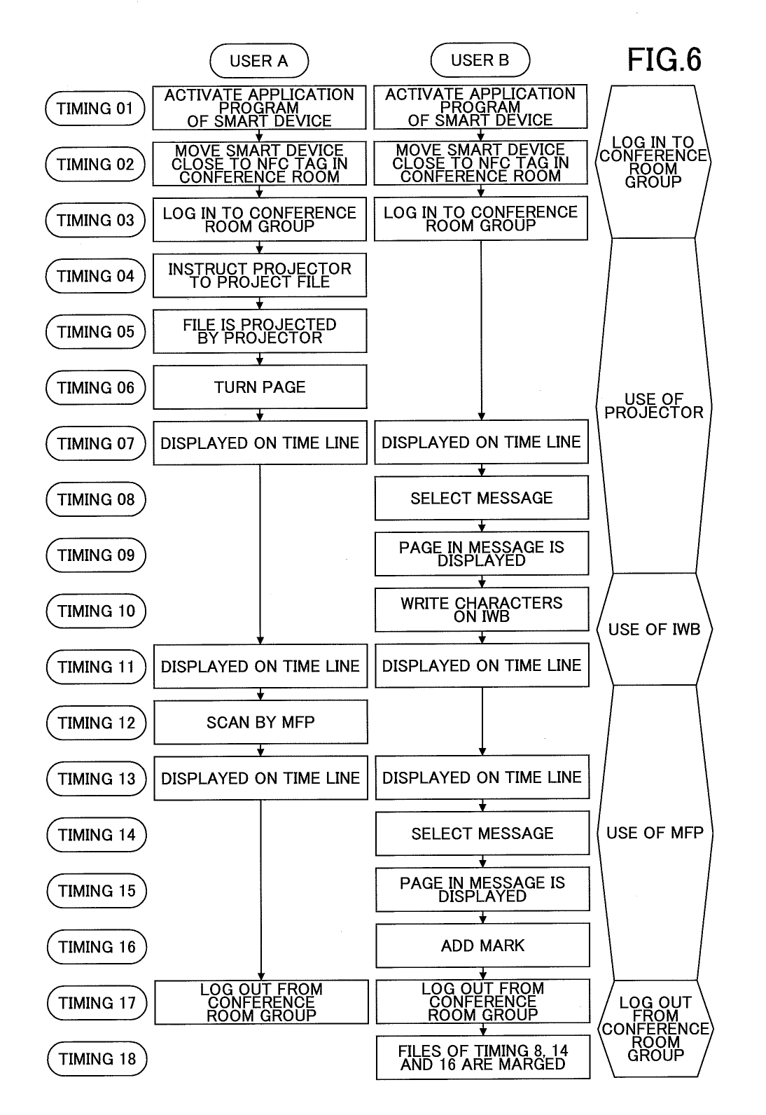

Here, an example is described in which a user A and a user B attend a conference by the conference system 1, and files stored in a storage of the data processing apparatus 10 and a document of a handy paper medium are used at timing of FIG. 6.

FIG. 6 is a timing chart illustrating an example of an overview of a use case. The timing chart illustrated in FIG. 6 includes log in to a conference room group, use of the projector 13, use of the IWB 16, use of the MFP 15 and log out from the conference room group.

Log in to the conference room group is performed during “timing 01” to “timing 03”. Each of the user A and the user B activates an application program of the smart device 11. Each of the user A and the user B moves the smart device 11 close to a NFC tag, which is an example of the near field wireless device 17, in the conference room and obtains data for logging in the conference room group, which will be explained later.

Then, each of the user A and the user B causes the smart device 11 to log in to the conference room group. As such, the user A and the user B can have their smart devices 11 belong to the conference room group. After belonging to the conference room group, a user is capable of using the electronic device such as the projector 13 that belongs to the conference room group.

Use of the projector 13 is performed during “timing 04” to “timing 09”. The user A instructs the projector 13 to project a file from the smart device 11. The smart device 11 of the user A requests the projector 13 to project the file and causes the projector 13 to project the file.

The user A operates the smart device 11 to turn a page of the file that is projected by the projector 13. The smart device 11 of each of the user A and the user B displays an image of the page turned by the operation of the user A on a displayed time line, which will be explained later, as a message.

When the user B selects, by tapping or the like, the message including the image of the page displayed on the time line of the smart device 11, a preview of the page is displayed. The operation content by the user B, that the use B selects the message on the time line, is stored as a message history.

Use of the IWB 16 is performed during “timing 10” to “timing 11”. For example, the user B writes characters as a memo on the IWB 16. The IWB 16 generates a file of the characters written by the user B and sends the file to the data processing apparatus 10.

The smart device 11 of each of the user A and the user B receives the file of the characters as a message. The smart device 11 of each of the user A and the user B displays the file of the characters written by the user B on the time line as a message.

Use of the MFP is performed during “timing 12” to “timing 16”. The user A scans a document by the MFP 15. The MFP 15 sends a file read from the document by scanning to the data processing apparatus 10.

The smart device 11 of each of the user A and the user B receives the file of the document as a message. The smart device 11 of each of the user A and the user B displays the file of the document scanned by the user A on the time line as a message. When the user B selects, by tapping of the like, the message including the image of the document displayed on the time line of the smart device 11, a preview of the page of the image of the document is displayed. The user B is capable of adding a mark on the page whose preview is displayed. The operation content by the user B, that the use B selects the message on the time line or the user B adds the mark, is stored as a message history.

Log out from the conference room group is performed during “timing 17” to “timing 18”. Each of the user A and the user B causes the smart device 11 to log out from the conference room group. The smart device 11 of the user B refers to the message histories and merges pages related to operations by the user B into a single file based on the operation contents performed by the user B. For example, in the timing chart of FIG. 6, the contents operated by the user B at the “timing 8”, the “timing 14” and the “timing 16 are merged into a single file.

### (Log in to Conference Room Group)

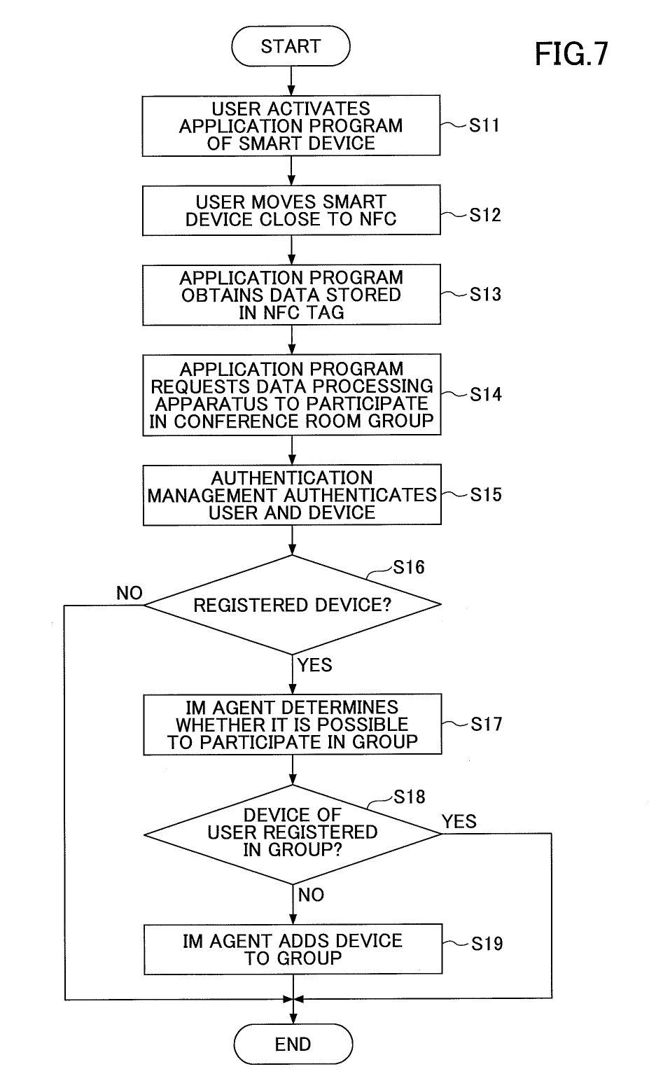

FIG. 7 is a flowchart illustrating an example of a log-in process to a conference room group. By the process of the flowchart illustrated in FIG. 7, the user can cause the smart device 11 (application program) to recognize starting of a conference.

Here, in the conference system 1 of the embodiment, by considering security, it is assumed that the data processing apparatus 10 and the smart device 11 are associated with each other and safely connected with each other. Further, in the conference system 1 of the embodiment, it is assumed that the group list includes a conference room group, and the electronic device such as the projector 13 in the conference room is registered as a member in the member list of the conference room group.

In step S11, each of the user A and the user B activates an application program of the smart device 11 that is used in the conference. It is assumed that the application program activated here can obtain a file stored in the data processing apparatus 10 and operate the electronic device such as the projector 13 used in the conference in addition to managing the association between the conference room group and the smart device 11.

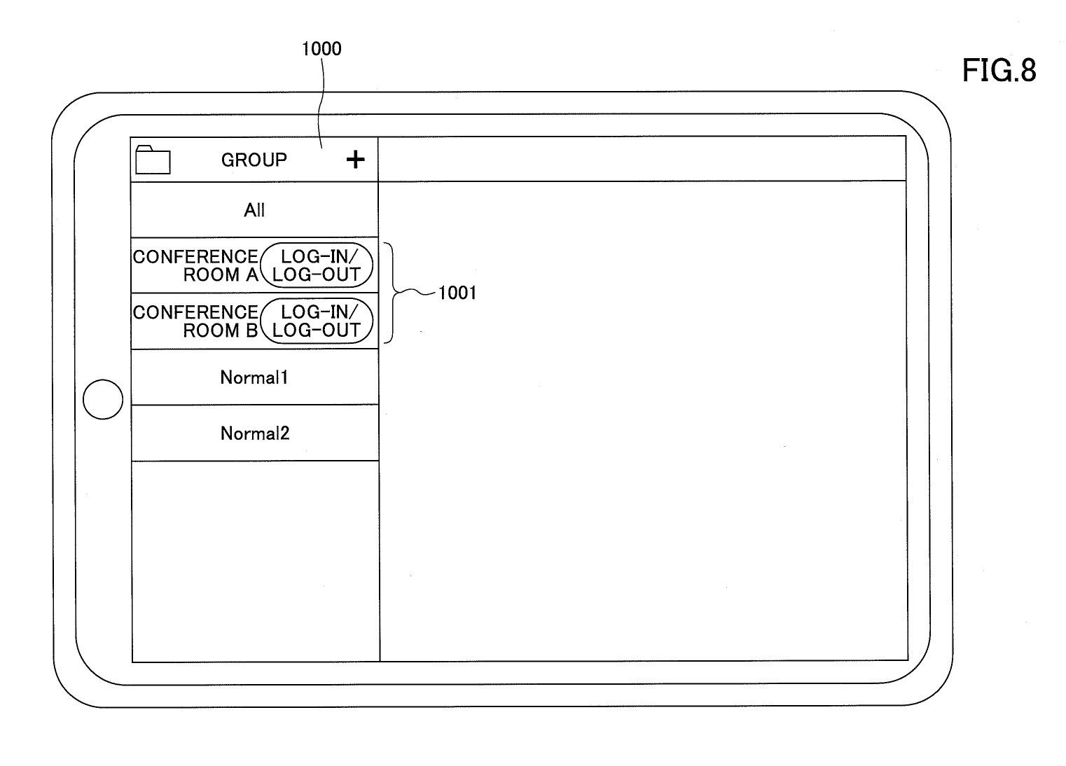

FIG. 8 is an image view illustrating an example of a group list screen 1000. The group list screen 1000 as illustrated in FIG. 8 is displayed on the smart device 11 in order to explicitly indicate a conference room group that is to be used to a user, in the conference system 1 of the embodiment.

The group list screen 1000 of FIG. 8 displays groups that are previously registered in a group list of the data processing apparatus 10 as a list. The group list screen 1000 displays normal groups each of whose group type is normal and conference room groups each of whose type is a conference room as the list. As illustrated in FIG. 8, a “log-in/log-out” button 1001 is provided at a display area of each of the conference room groups, and an instruction of log-in/log-out is acceptable from the user. As such, according to the conference system 1 of the embodiment, the user can show his/her intention to log-in/log-out to and from the conference room group by pressing the “log-in/log-out” button 1001.

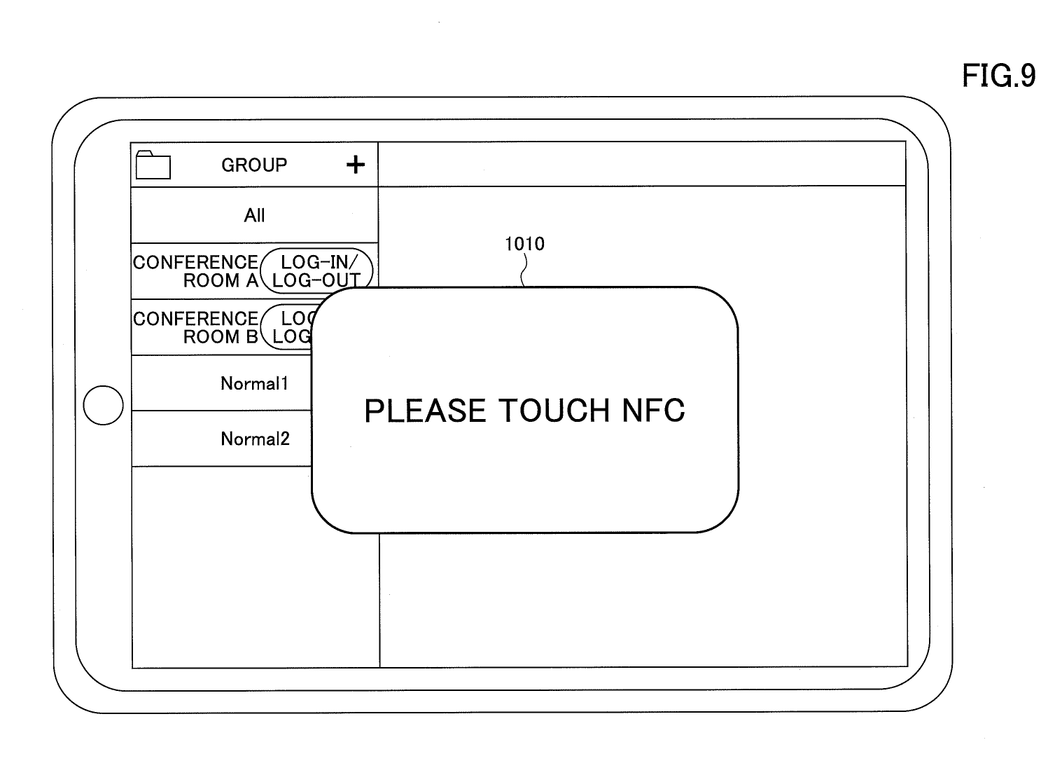

Referring back to FIG. 7, in step S12, the smart device 11 displays an NFC touch request screen 1010 as illustrated in FIG. 9. FIG. 9 is an image view illustrating an example of the NFC touch request screen 1010. The NFC touch request screen 1010 of FIG. 9 is an example of a screen that requests the user to touch the NFC, which is an example of the near field wireless device. Further, the NFC touch request screen 1010 of FIG. 9 is an example in which a touch request to the NFC is displayed by a dialog.

The user moves the smart device 11 close to the NFC tag in accordance with the request by the NFC touch request screen 1010. Referring back to FIG. 7, in step S13, the data obtaining unit 65 of the smart device 11 obtains data stored in the NFC tag. The data stored in the NFC tag includes group ID of the conference room group and an IP address of the data processing apparatus 10, for example.

Here, although an example is described in which the group ID of the conference room group and the IP address of the data processing apparatus 10 are stored in the NFC tag, a technique that can similarly store the data may be used instead. For example, a two-dimensional code such as a QR code (registered trademark) that stores the group ID of the conference room group and the IP address of the data processing apparatus 10 may be used instead of the NFC tag. In the conference system 1 of the embodiment, a two-dimensional code that stores the group ID of the conference room group and the IP address of the data processing apparatus 10 may be printed and provided in the conference room.

In step S14, the requesting unit 62 of the smart device 11 requests the data processing apparatus 10 to participate in the conference room group by designating the group ID of the conference room group obtained in step S13.

In step S15, the authentication management unit 34 of the data processing apparatus 10 receives a request to participate in the conference room group from the smart device 11 via the Web API unit 31 and the Web control unit 32. The authentication management unit 34 performs a user authentication and a device authentication using the user ID and the smart device ID included in the participation request to the conference room group.

In step S16, based on a request of the user authentication and the device authentication in step S15, the authentication management unit 34 determines whether the device is a registered device for which connection to the data processing apparatus 10 is permitted. The process of step S16 is performed in order to secure security, and if the device is not the registered one, the result becomes an error and the log-in process to the conference room group ends in failure.

When the device is the registered one, the IM agent unit 33 determines whether it is possible for the device to participate in the conference room group in step S17. In step S17, if the smart device 11 included in the participation request is not registered in the member list of the requested conference room group, it is determined that it is possible to participate in the conference room group.

If the smart device 11 included in the participation request is not registered in the member list of the conference room group (NO in step 18), the IM agent unit 33 adds the smart device 11 in the member list of the requested conference room group, in step S19. By the process of step S19, the smart device 11 logs-in the conference room group.

Further, when the smart device 11 included in the participation request is registered in the member list of the conference room group, this means that the smart device 11 is already logged in the conference room group, and the process of step S19 is skipped.

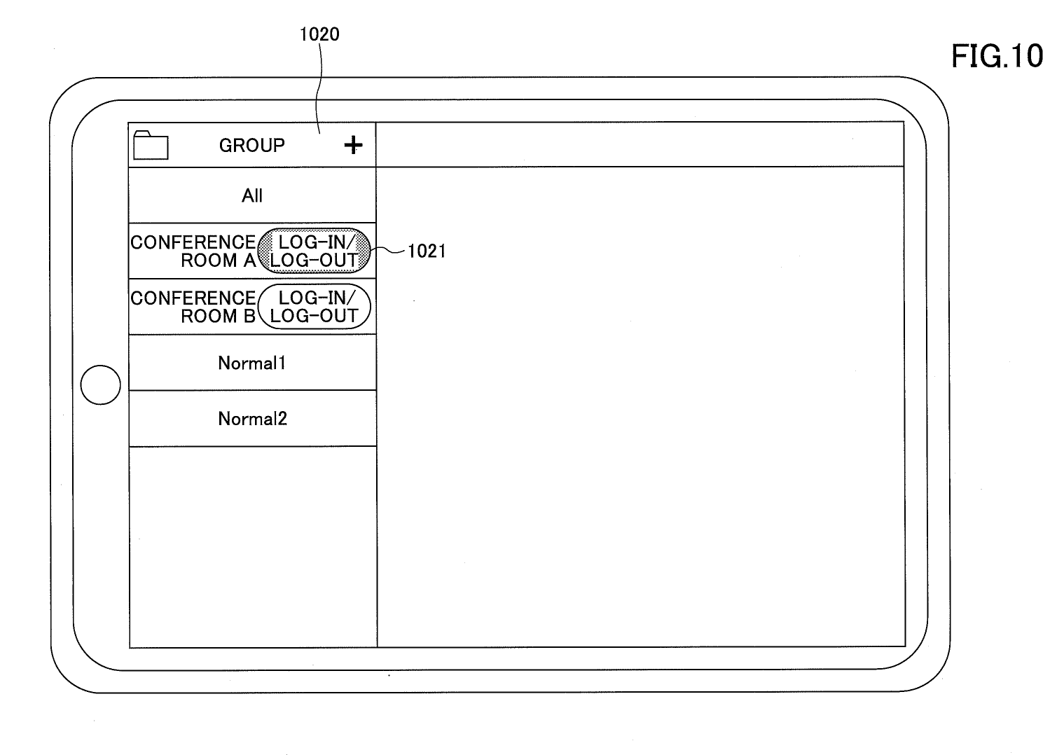

After being logged in the conference room group, the group list screen 1000 of FIG. 8 transits to a group list screen 1020 of FIG. 10. In FIG. 10, visual such as color or the like of a “log-in/log-out button” 1021 is changed from that of the “log-in/log-out button” 1001 for indicating that the user is already logged in the respective conference room group. FIG. 10 is an image view illustrating an example of the group list screen after being logged in.

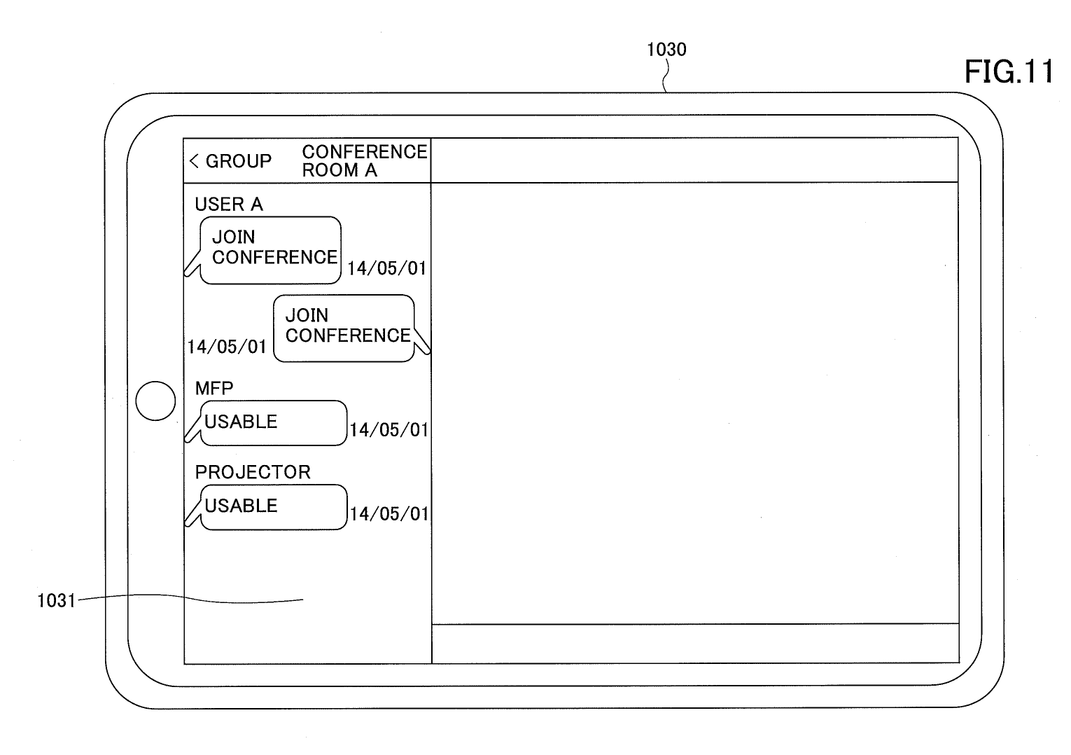

Further, after being logged in, the smart device 11 displays a conference status screen 1030 including a time line screen 1031 as illustrated in FIG. 11, for example. FIG. 11 is an image view illustrating an example of the conference status screen 1030 including the time line screen 1031.

For example, in the time line screen 1031 of FIG. 11, messages indicating that the user A and the user B participate in the conference room group, respectively, and messages indicating that the electronic devices such as the MFP 15 or the projector 13 registered in the conference room group are usable, are displayed. Here, the order of the messages in FIG. 11 is just an example and the messages indicating that the electronic devices such as the MFP 15 or the projector 13 registered in the conference room group are usable may be displayed first. Here, the structure of the conference status screen 1030 of FIG. 11 is the same as a conference status screen of a normal group.

As the time line screen 1031 of FIG. 11 is shared, each of the user A and the user B who participates the conference room group can confirm other users who are already logged in the conference room group, or the electronic device capable of being used in the conference room group on the time line screen 1031.

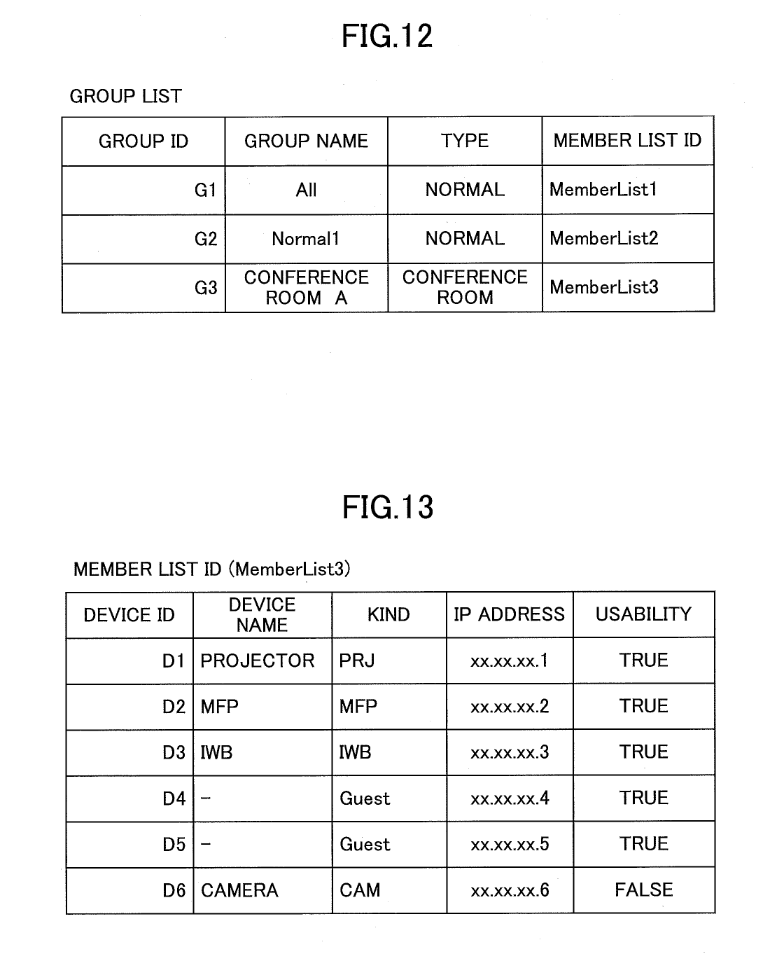

FIG. 12 is a view illustrating an example of a structure of a group list stored in a data storing unit. The group list of FIG. 12 includes data items such as group ID, group name, type and member list ID.

The group ID is an example of identification data allocated to each group. Further, the group name is a name of each group. The type is identification data that identifies whether each group is a normal group, which is a conventional message group or a conference room group of the embodiment. The member list ID is data for uniquely specifying the member list of each group.

Each of the groups delivers a message in accordance with the member list as illustrated in FIG. 13 that is uniquely specified by the member list ID. FIG. 13 is a view illustrating an example of a structure of a member list stored in the data storing unit.

In the member list of FIG. 13, a member list of the group identified by the group ID “G3” of the group list of FIG. 12 is illustrated as an example. As the member list of FIG. 13 is the member list of the conference room group, an electronic device in the conference room is also registered in addition to the smart device 11.

The member list of FIG. 13 includes data items such as device ID, device name, kind, IP address and usability. The device ID is an example of identification data allocated to the smart device 11 or the electronic devices in the conference room. As it is necessary for the device ID to be different even for the same type of devices, the device ID is unique ID. Here, in this embodiment, as it is assumed that the devices are connected to the network N3, a MAC address may be used as the device ID.

The device name is a name of the electronic device such as the projector 13. The kind indicates a kind of the electronic device such as the projector 13. Here, in the member list of FIG. 13, the kind of the smart device 11 added by the participation request is registered as a “Guest”. The data processing apparatus 10 is capable of performing an operation in accordance with the kind of the smart device 11 or the electronic device such as the projector 13.

The IP address is an example of an address of the smart device 11 or the electronic devices on a network. It is preferable that static IP addresses are used because the conference system 1 of the embodiment is operated in the conference room. The usability includes “TRUE” that indicates power is ON and communication with the data processing apparatus 10 can be performed, and “FALSE” that indicates power is OFF and communication with the data processing apparatus 10 cannot be performed.

### (Use of Projector)

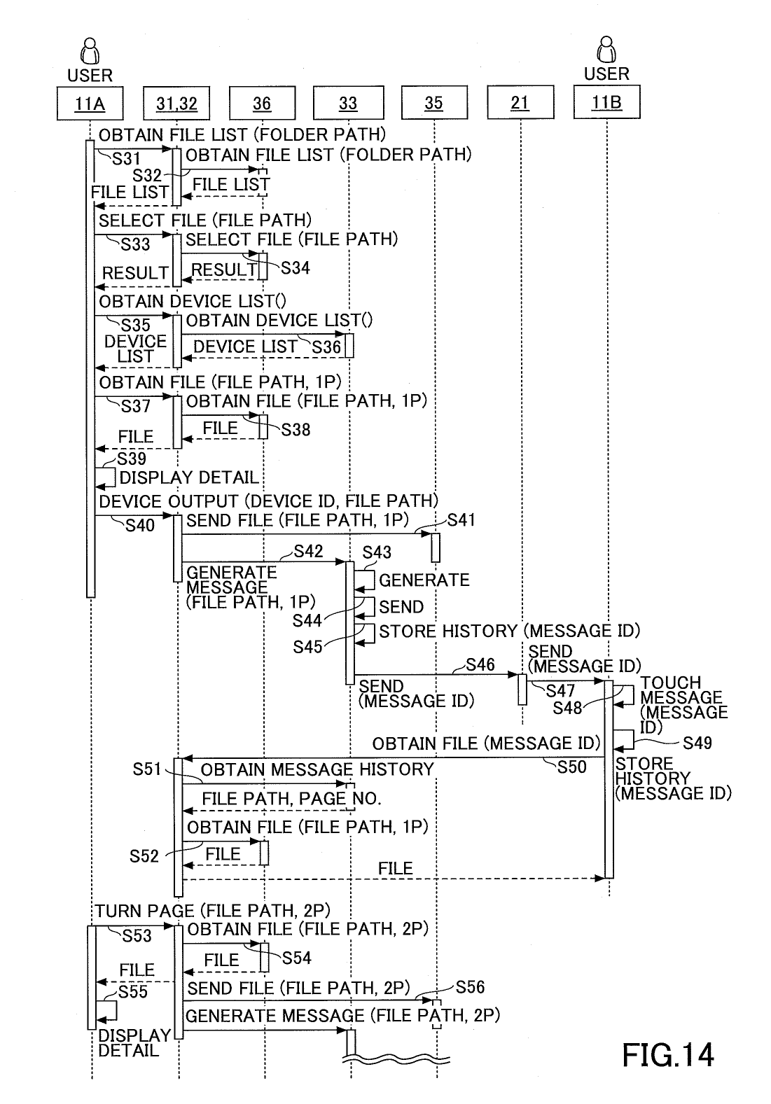

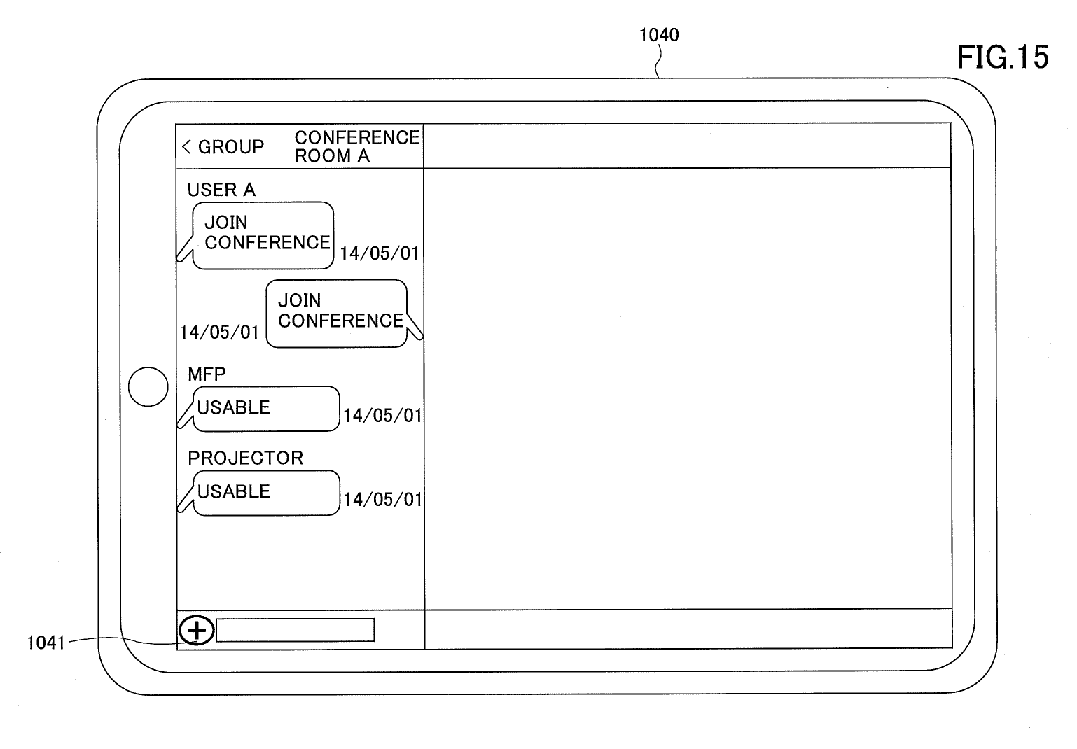

FIG. 14 is a sequence diagram illustrating an example of a process of using the projector 13. In FIG. 14, it is assumed that the smart device 11 operated by the user A is referred to as a smart device 11A and the smart device 11 operated by the user B is referred to as a smart device 11B. Further, although boxes of units are given only numerals and names of the units are not illustrated in the boxes in FIG. 14, the boxes with numerals correspond to the units as illustrated in FIG. 1, FIG. 5 or the like and described in the specification. FIG. 15 is an image view illustrating an example of a conference status screen 1040 including a file selection button 1041.

The user A instructs to display the file list by pressing the file selection button 1041 in the conference status screen 1040 of FIG. 15. By the instruction to display the file list from the user A, the smart device 11A requests the data processing apparatus 10 to obtain the file list by designating a folder path in step S31 of FIG. 14.

Upon receiving the request to obtain the file list, in step S32, the Web API unit 31 and the Web control unit 32 of the data processing apparatus 10 request the file management unit 36 to obtain the file list by designating the folder path. The file management unit 36 generates a file list based on the designated folder path and sends the file list to the smart device 11A of the user A via the Web API unit 31 and the Web control unit 32.

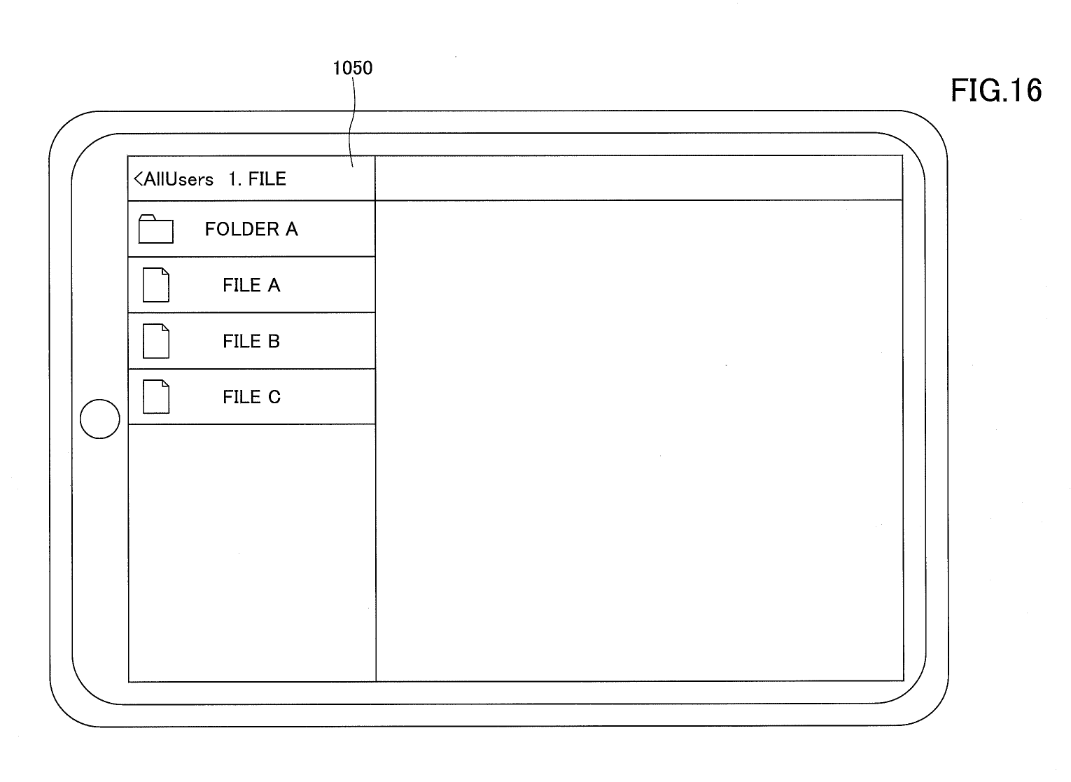

The screen control unit 64 of the smart device 11A displays a file list screen 1050 as illustrated in FIG. 16, for example, on the display 616 using the received file list. FIG. 16 is an image view illustrating an example of the file list screen 1050. When the user selects a folder in the file list screen 1050, the smart device 11A performs the processes of steps S31 and S32 again and displays the file list screen of the folder path selected by the user A.

Referring back to FIG. 14, in step S33, the user A selects a file to be projected by the projector 13 from the file list screen 1050 of FIG. 16. The smart device 11A requests the data processing apparatus 10 to select the file by designating the file path of the file selected by the user A.

Upon receiving the request to select the file, in step S34, the Web API unit 31 and the Web control unit 32 of the data processing apparatus 10 request the file management unit 36 to select the file by designating the file path. The file management unit 36 tries to select the file based on the designated file path and sends the result of the selection of the file to the smart device 11A of the user A via the Web API unit 31 and the Web control unit 32. Here, it is assumed that the smart device 11A receives the success of selection of the file.

In step S35, the smart device 11A requests the data processing apparatus 10 to obtain the device list. Upon receiving the request to obtain the device list, in step S36, the Web API unit 31 and the Web control unit 32 of the data processing apparatus 10 requests the IM agent unit 33 to obtain the device list. The IM agent unit 33 generates a device list based on the member list of FIG. 13 and sends it to the smart device 11A of the user A via the Web API unit 31 and the Web control unit 32.

It is possible for the smart device 11A to display a device list at this stage and have the user A select an electronic device by which the file is displayed. However, the request to obtain a file is performed first in order to cause the smart device 11A display the file selected in step S33 as well.

In step S37, the smart device 11A requests the data processing apparatus 10 to obtain the file by designating the file path and the page (1P, for example) of the file selected by the user in step S33.

Upon receiving the request to obtain the file, in step S38, the Web API unit 31 and the Web control unit 32 of the data processing apparatus 10 request the file management unit 36 to obtain the file by designating the file path and the page. The file management unit 36 sends the file based on the designated file path and the page to the smart device 11A of the user A via the Web API unit 31 and the Web control unit 32.

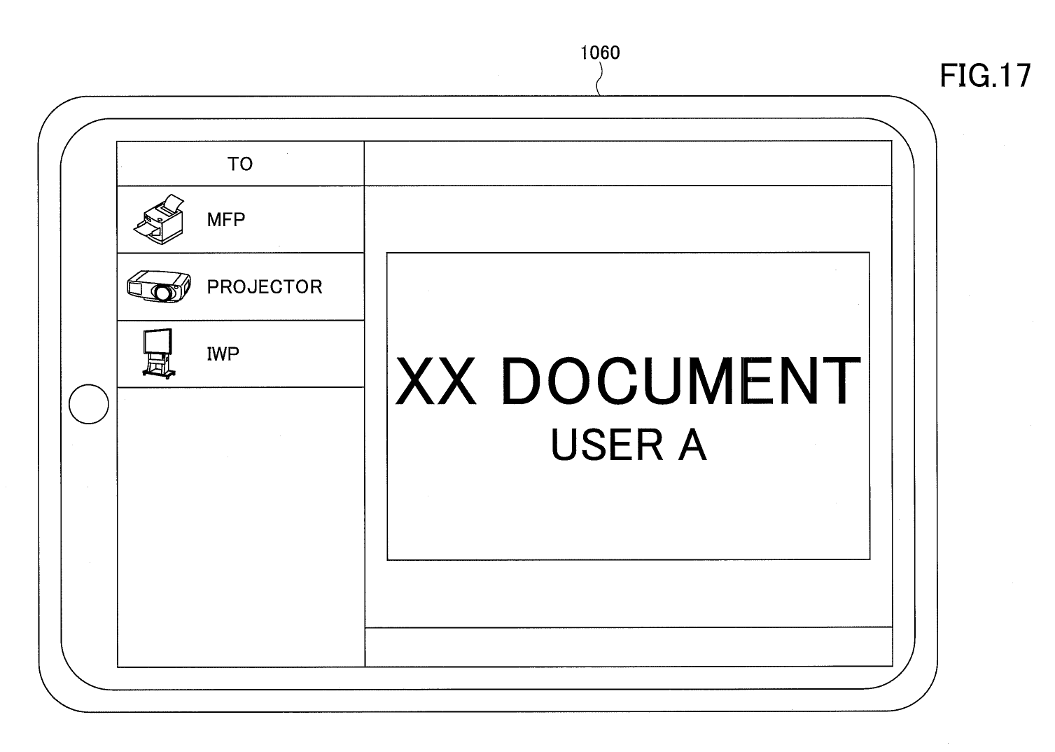

In step S39, the screen control unit 64 of the smart device 11A controls the display 616 to display a device list screen 1060 as illustrated in FIG. 17, for example, by using the received device list and the file. FIG. 17 is an image view illustrating an example of the device list screen. In the device list screen 1060 of FIG. 17, an example is illustrated in which the electronic devices of the member list of the conference room group except the smart devices are displayed as the device list and the first page of the file selected by the user A is displayed.

Referring back to FIG. 14, in step S40, the user A selects an electronic device to output the file from the device list screen 1060 of FIG. 17. Here, it is assumed that the projector 13 is selected. The smart device 11A requests the data processing apparatus 10 for a device output by designating device ID of the projector 13 selected by the user A and the file path.

Upon receiving the request of device output, in step S41, the Web API unit 31 and the Web control unit 32 of the data processing apparatus 10 request the file sending unit 35 to send the file to the projector 13 by designating the file path and the page. The file sending unit 35 sends the file designated by the file path and the page to the projector 13 and causes the projector 13 to project an image of the file.

Further, upon receiving a request of device output, in step S42, the Web API unit 31 and the Web control unit 32 of the data processing apparatus 10 request the IM agent unit 33 to generate a message by designating the file path and the page. In step S43, the IM agent unit 33 generates a message in which an image to be projected by the projector 13 is embedded.

In step S44, the IM agent unit 33 selects the smart device 11B as a device to send the message by referring to the member list of FIG. 13. In step S45, the IM agent unit 33 stores a message history. The message history stored here is explained later in detail.

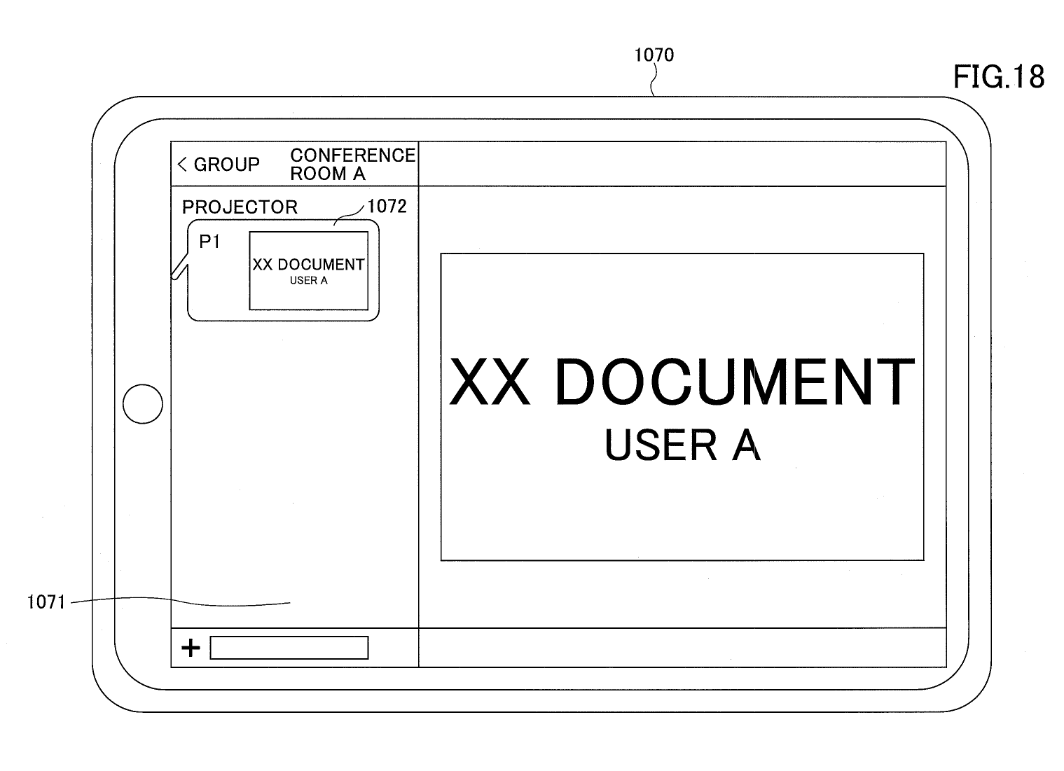

In step S46, the IM agent unit 33 sends the message to the IM server 21. In step S47, the IM server 21 sends the message from the data processing apparatus 10 to the smart device 11B. Based on the sent message, the smart device 11B displays a conference status screen 1070 including a time line screen 1071 as illustrated in FIG. 18.

FIG. 18 is an image view illustrating an example of the conference status screen 1070 when starting projection by the projector 13. In the conference status screen 1070 of FIG. 18, the sent message 1072 is displayed on the time line screen 1071. In the message 1072, the image of the file and the page number of the file that is started to be projected by the projector 13 are displayed.

Further, the device name “projector” of the projector 13 is displayed on the time line screen 1071 of FIG. 18 as a speaker (sender) of the message 1072. Here, the content of the message 1072 may be altered based on a kind of electronic devices. As such, in the conference system 1 of the embodiment, the user B can confirm the image of the file projected by the projector 13 by the user A on the time line screen 1071 of the conference status screen 1070 of FIG. 18.

Next, a case is described in which the user B touches the message 1072 of FIG. 18. Referring to FIG. 14, it is assumed that the user B touches the message 1072 at the smart device 11B in step S48. In step S49, the smart device 11B stores a history that the message 1072 is touched as history data. In step S50, the smart device 11B requests the data processing apparatus 10 to obtain a file by designating message ID of the message touched by the user B.

Upon receiving a request to obtain a file, in step S51, the Web API unit 31 and the Web control unit 32 of the data processing apparatus 10 request the IM agent unit 33 for a message history by designating the message ID. The IM agent unit 33 reads out the file path and the page number from the message history based on the designated message ID and sends them to the Web API unit 31 and the Web control unit 32. In step S52, the Web API unit 31 and the Web control unit 32 obtain a file from the file management unit 36 by designating the file path and the page number and sends it to the smart device 11B.

Here, although an example is described in which the file is obtained from the data processing apparatus 10 by designating the message ID in the sequence diagram of FIG. 14, the file may be included in the message itself.

In step S53, the user A instructs a paging operation from the conference status screen 1070 of FIG. 18. The smart device 11A requests the data processing apparatus 10 to obtain the file by designating the file path and the page of the file (2P, for example) selected by the paging operation by the user in step S53.

Upon receiving a request to obtain the file, in step S54, the Web API unit 31 and the Web control unit 32 of the data processing apparatus 10 request the file management unit 36 to obtain the file by designating the file path and the page. The file management unit 36 sends the file based on the designated file path and the page to the smart device 11A of the user A via the Web API unit 31 and the Web control unit 32.

In step S55, the screen control unit 64 of the smart device 11A displays 2 page of the file that is newly selected by turning the page instead of 1 page of the file displayed on the conference status screen 1070 of FIG. 18.

In step S56, the Web API unit 31 and the Web control unit 32 of the data processing apparatus 10 request the file sending unit 35 to send the file to the projector 13 by designating the file path and the page. The file sending unit 35 sends the file designated by the file path and the page to the projector 13 and causes the projector 13 to project the image of the file.

Hereinafter, by similar processes as steps S42 to S47, the Web API unit 31 and the Web control unit 32 of the data processing apparatus 10 request the IM agent unit 33 to generate a message by designating a file path and a page. The IM agent unit 33 generates a message in which the image projected by the projector 13 is embedded.

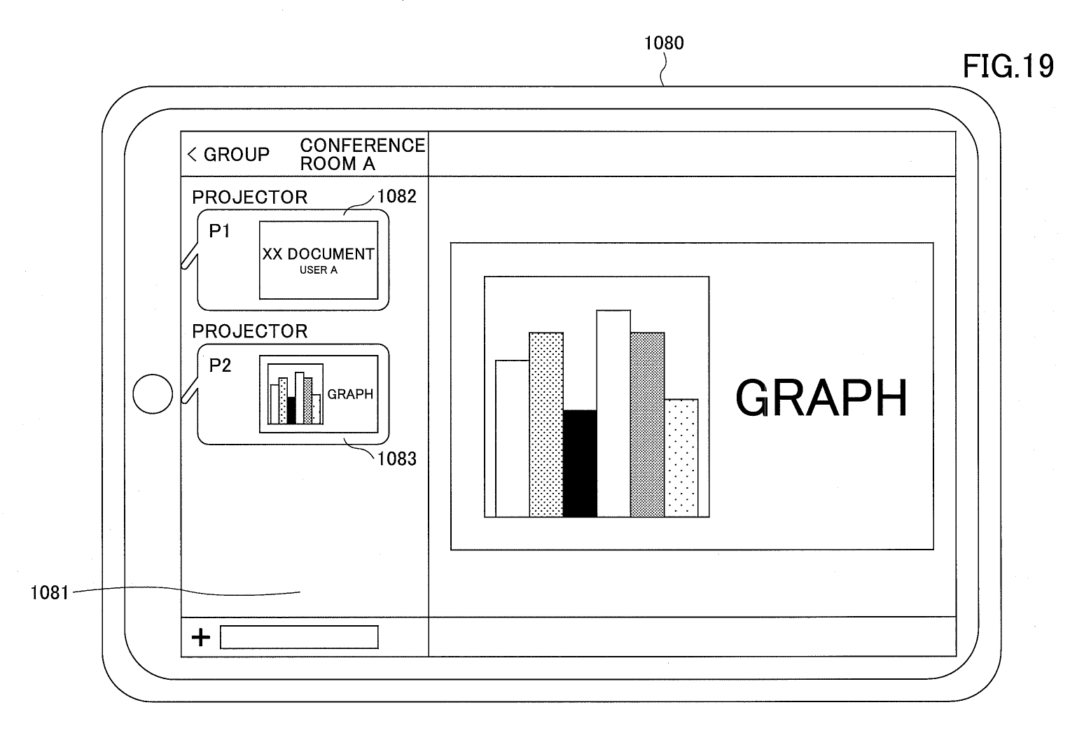

The IM agent unit 33 selects the smart device 11B to send the message by referring to the member list of FIG. 13. Further, the IM agent unit 33 stores a message history. The IM agent unit 33 sends the message to the IM server 21. The IM server 21 sends the message from the data processing apparatus 10 to the smart device 11B. The smart device 11B displays a conference status screen 1080 including a time line screen 1081 as illustrated in FIG. 19 based on the sent message.

FIG. 19 is an image view illustrating an example of the conference status screen 1080 after turning a page. In the conference status screen 1080 of FIG. 19, the messages 1082 and 1083 are displayed on the time line screen 1081.

In the message 1082, an image of the file that is projected by the projector 13 and a page number of the file are displayed. Further, in the message 1083, an image of the file that is newly projected by the projector 13 by turning the page and its page number are displayed.

As such, according to the conference system 1 of the embodiment, when the user A changes the image of the file projected by the projector 13 by turning the page to a next page, a message including an image of the next page is added on the time line screen 1081 of the conference status screen 1080. The user B can confirm the image of the page newly projected by the projector 13 by turning the page on the time line screen 1081 of the conference status screen 1080 of FIG. 19.

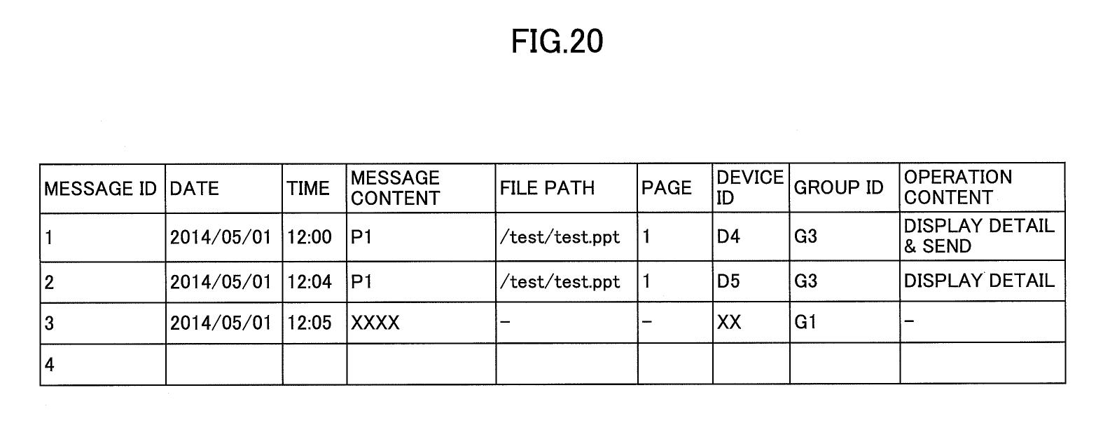

Here, the message history stored in the data processing apparatus 10 has a structure as illustrated in FIG. 20. FIG. 20 is a view illustrating an example of a structure of the message history. The message history illustrated in FIG. 20 includes data items such as message ID, date, time, message content, file path, page, device ID, group ID and operation content.

The message ID is an example of identification data uniquely allocated to each message. The date and time indicate date and time when the message is generated. The message content indicates a content displayed as a message body. The file path and the page are data for specifying the image displayed in the message 1072 or the like.

The device ID is identification data of the smart device or the electronic device from which the request is sent. The group ID is identification data of a group that commonly shares the message 1072 or the like. Further, the operation content indicates a content of an operation by a user such as display detail or the like. Due to the message history of FIG. 20, the IM agent unit 33 can obtain the file path and the page number, search the smart device 11 from which the request is sent or the like in accordance with the message ID.

### (Use of IWB)

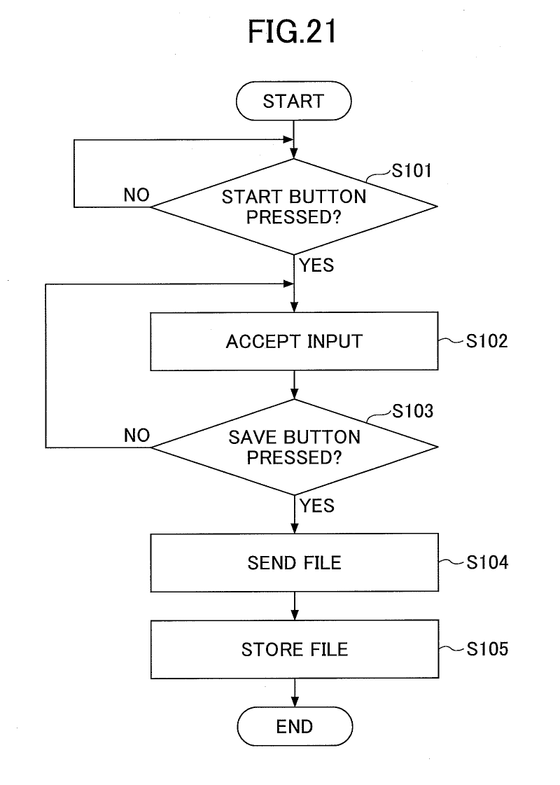

FIG. 21 is a flowchart illustrating an example of a process of using the IWB 16. In the IWB 16, the user can explicitly designate starting and ending of writing the characters, the graphics or the like. For this, a case is assumed in which a snapshot is obtained at a stage when the discussion is over in the conference or the like.

In step S101, the user indicates the IWB 16 for starting writing by pressing a start button or the like of the IWB 16. When the start button is pressed (YES in S101), the IWB 16 accepts input of characters or graphics from the user until a save button is pressed, in step S102.

When the save button is pressed (YES in S103), the IWB 16 generates a file of the characters or graphics written by the user, sends the file to the data processing apparatus 10 and requests the data processing apparatus 10 to store the file, in step S104.

In step S105, the file management unit 36 of the data processing apparatus 10 receives the request to store the file via the Web API unit 31 and the Web control unit 32 and stores the file in the file storing unit 39.

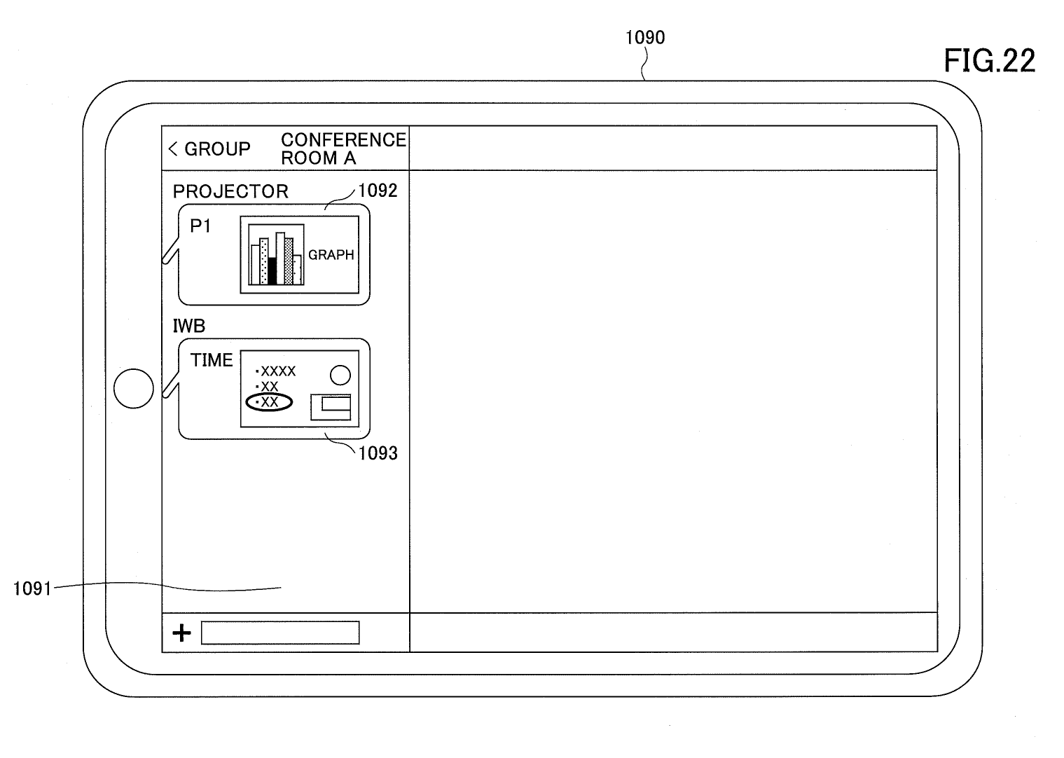

Further, the Web API unit 31 and the Web control unit 32 may display messages in each of which an image of the characters, the graphics or the like written by the user on the IWB 16 as illustrated in FIG. 22 by the processes similar to those of steps S42 to S47 of FIG. 14.

FIG. 22 is an image view illustrating an example of the conference status screen after using the IWB 16. In the conference status screen 1090 of FIG. 22, the sent messages 1092 and 1093 are displayed on the time line screen 1091.

In the message 1092, an image of the file and a page number of the file that is started to be projected by the projector 13 are displayed. Further, in the message 1093, the image of the characters, the graphics or the like written by the user on the IWB 16 and time are displayed.

In the conference system 1 of the embodiment, when a user writes characters, graphics or the like on the IWB 16 and presses a save button, a message including an image of the characters, the graphics or the like written by the user on the IWB 16 is added on the time line screen 1091 of the conference status screen 1090. The user can confirm the image of the characters, the graphics or the like written by the user on the IWB 16, on the time line screen 1091 of the conference status screen 1090 of FIG. 22.

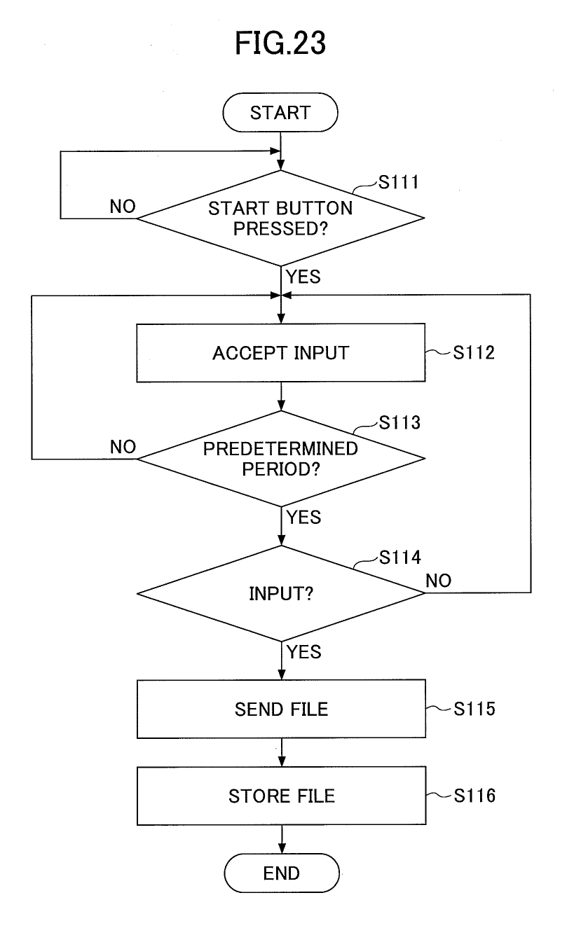

Although the user explicitly designates starting and ending of writing the characters, the graphics or the like in FIG. 21, the IWB 16 may be configured such that the image of the characters, the graphics or the like written by the user are automatically stored as illustrated in FIG. 23.

FIG. 23 is a flowchart illustrating another example of the process of using the IWB 16. In step S111, the user indicates the IWB 16 for starting writing by pressing a start button or the like of the IWB 16. When the start button is pressed (YES in S111), the IWB 16 accepts input of characters or graphics from the user until a save button is pressed, in step S112.

After a predetermined period has passed (YES in S113), the IWB 16 determines whether the user newly inputs characters or graphics, in step S114. When the user does not newly input characters or graphics, the IWB 16 returns to step S112 and accepts input of characters, graphics or the like from the user. When the user newly inputs characters or graphics (YES in S114), the IWB 16 proceeds to step S115, generates a file of the characters, the graphics or the like written by the user, and sends the file to the data processing apparatus 10 to be stored.

In step S115, the file management unit 36 of the data processing apparatus 10 receives the request to store the file via the Web API unit 31 and the Web control unit 32 and stores the file in the file storing unit 39.

Further, the Web API unit 31 and the Web control unit 32 may display a message in which an image of characters, graphics or the like written by the user on the IWB 16 as illustrated in FIG. 22 by the processes similar to those of steps S42 to S47 of FIG. 14.

In the conference system 1 of the embodiment, when a user writes characters, graphics or the like on the IWB 16, a message including the image of the characters, the graphics or the like written by the user on the IWB 16 is added to the time line screen 1091 of the conference status screen 1090 every predetermined period. The user can confirm the image of the characters, the graphics or the like written on the IWB 16, on the time line screen 1091 of the conference status screen 1090 of FIG. 22.

### (Use of MFP)

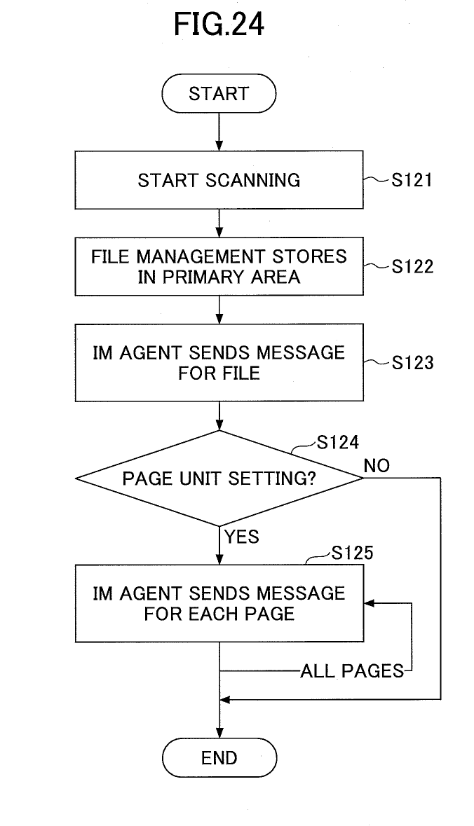

FIG. 24 is a flowchart illustrating an example of a process of using the MFP 15. FIG. 24 illustrates a case in which a document is scanned by the MFP 15.

In step S121, the MFP 15 starts scanning. It is assumed that it is unnecessary to designate an address to send, as the MFP 15 cooperates with the data processing apparatus 10. Further, it is assumed that the MFP 15 is capable of setting whether to generate a message by a page unit or a file unit. By generating the message by a file unit, generation of many massages can be prevented when the number of pages is large by the conference system 1 of the embodiment.

In step S122, the MFP 15 sends the file, which is a scanned result, to the data processing apparatus 10 and requests the data processing apparatus 10 to store the file. The file management unit 36 of the data processing apparatus 10 receives the request to store the file via the Web API unit 31 and the Web control unit 32 and stores the file in the file storing unit 39.

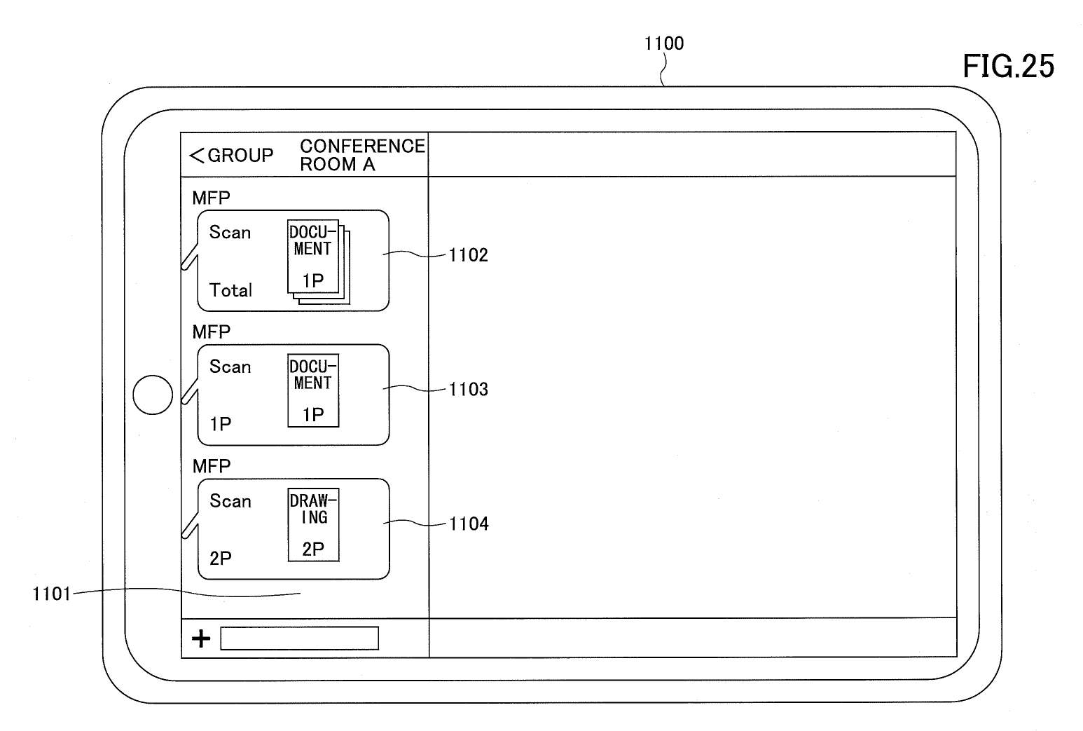

Further, the Web API unit 31 and the Web control unit 32 may display a message in which an image of the scanned result by the MFP 15 is displayed as illustrated in FIG. 25 by the processes similar to those of steps S42 to S47 of FIG. 14.

FIG. 25 is an image view illustrating an example of the conference status screen after scanning. In the conference status screen 1100 of FIG. 25, messages 1102 to 1104 are displayed on a time line screen 1101. In the message 1102, images of a scanned result are displayed by a file unit. In each of the messages 1103 and 1104, an image of a scanned result is displayed by a page unit.

Referring to FIG. 24, for example, the IM agent unit 33 generates the message in which the images of a scanned result is displayed by a file unit, and notifies the message to the smart device 11, in step S123.

Then, in step S124, the IM agent unit 33 determines whether it is set that a message is to be generated by a page unit. When it is set that the message is to be generated by a page unit (YES in S124), the IM agent unit 33 generates a message in which the image of scanned result is displayed by a page unit and sends it to the smart device 11, in step S125.

In the conference system 1 of the embodiment, when a user scans a document by the MFP 15, a massage including an image of the scanned result is added to the time line screen 1101 of the conference status screen 1100. Thus, the user can confirm the image scanned by the MFP 15 on the time line screen 1101 of the conference status screen 1100 of FIG. 25.

(Log out from Conference Room Group)

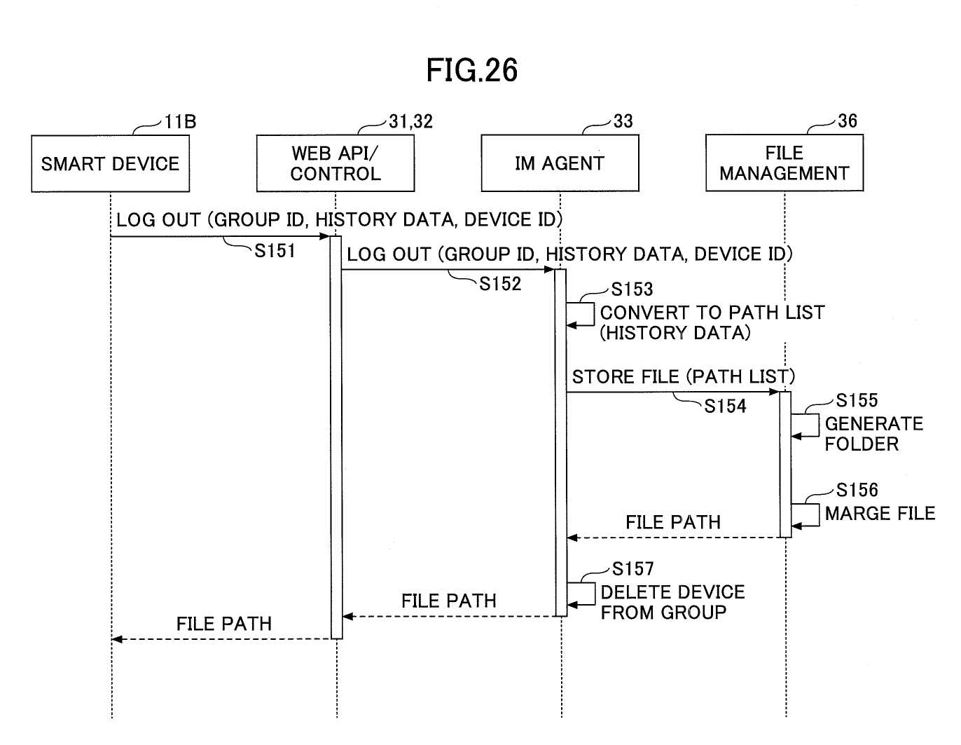

FIG. 26 is a sequence diagram illustrating an example of a log-out process from the conference room group. When the “log-in/log-out” button 1021 is pressed by the user B while the user B is logging in to the conference room group, the processes illustrated in the sequence diagram of FIG. 26 are started.

In step S151, the smart device 11B requests the data processing apparatus 10 to log out by designating the group ID, the history data and the device ID of own. Upon receiving the request of logging out, in step S152, the Web API unit 31 and the Web control unit 32 of the data processing apparatus 10 send the request of logging out to the IM agent unit 33.

In step S153, the IM agent unit 33 converts the history data designated by the request of logging out to path lists each indicating a file path and a page number. In step S154, the IM agent unit 33 requests the file management unit 36 to store the files by designating the path lists.

In step S155, the file management unit 36 generates a folder accessible by the user B. In step S156, the file management unit 36 merges one or more files indicated in the path list to a single file. Then, the file management unit 36 stores the merged file in the folder generated in step S155. The file management unit 36 returns the file path of the file stored in the folder to the IM agent unit 33.

In step S157, the IM agent unit 33 deletes a record of the smart device 11B from the member list illustrated in FIG. 13. Thereafter, the IM agent unit 33 notifies the file path of the merged file to the smart device 11B via the Web API unit 31 and the Web control unit 32.

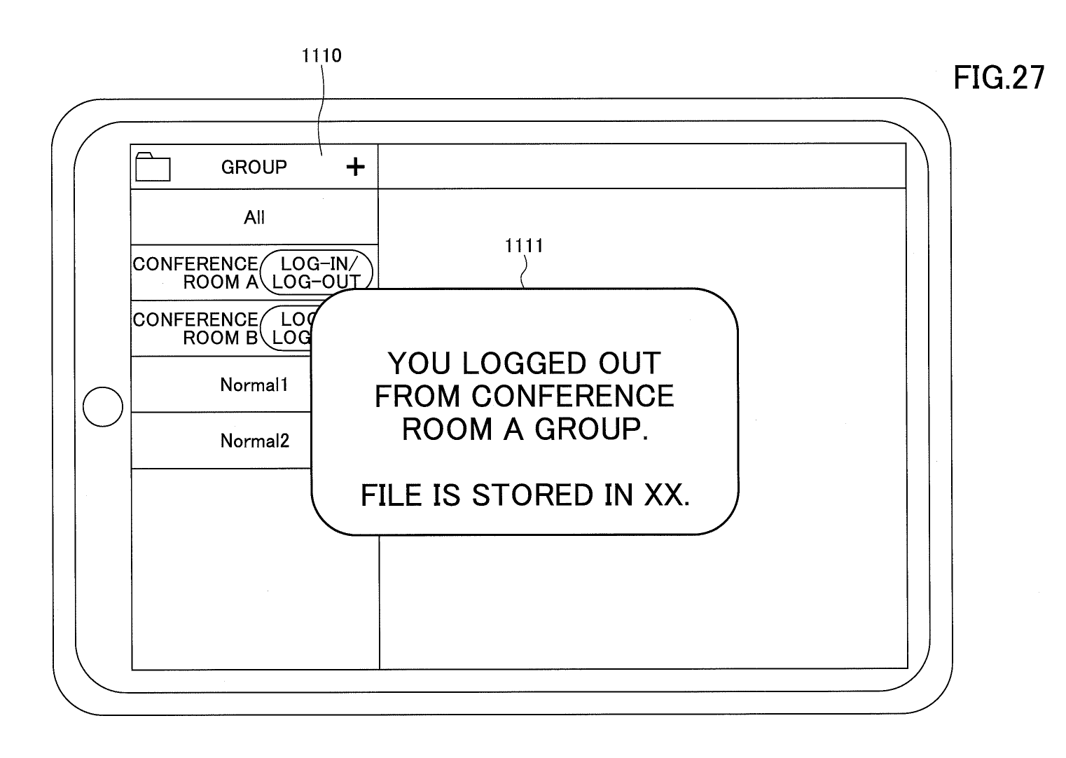

When the file path of the merged file is notified, the smart device 11B displays a group list screen 1110 with a message 1111 as illustrated in FIG. 27. FIG. 27 is an image view illustrating an example of the group list screen 1110 after being logged out. The file path of the file merged and stored in the folder by the data processing apparatus 10 in step S156 is displayed in the message 1111.

Thus, the user B can easily acquire, using the file path of the file in which images operated by the user B at “timing 8”, “timing 14” and “timing 16” of FIG. 6 are merged, the file. Here, in the group list screen 1110 of FIG. 27, it is indicated that the user is logged out from a conference room group by returning the visual such as color or the like of the “log-in/log-out button” 1021 to an original color or the like.

### Second Embodiment

In second embodiment, a function of prohibiting an acquisition of a file is added to the first embodiment. In the second embodiment, the user (speaker, for example) who projects a file by the projector 13 is capable of setting prohibition of an acquisition of the file for each page of the file, for example. Here, the structures of the second embodiment are the same as those of the first embodiment except a part, and explanations are not repeated for the same structures.

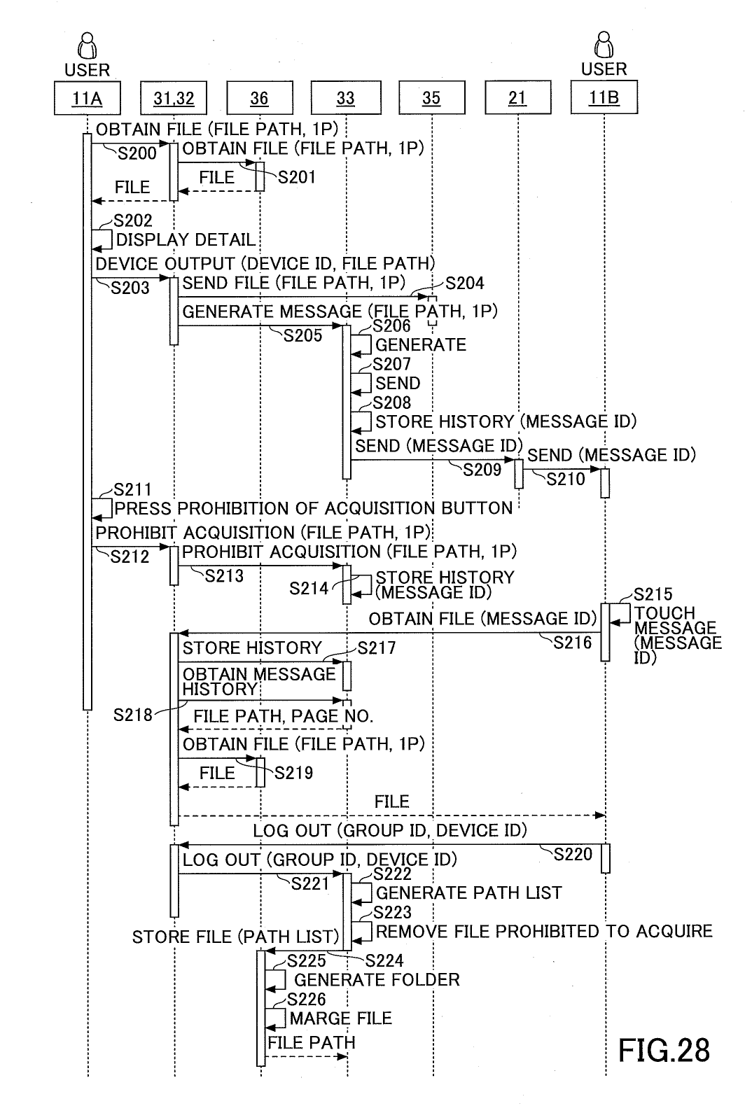

FIG. 28 is a sequence diagram illustrating an example of a function of prohibiting an acquisition of the file. As processes of steps S200 to S210 are the same as those of steps S37 to S47 of FIG. 14, explanations are not repeated. Further, although boxes of units are given only numerals and names of the units are not illustrated in the boxes in FIG. 28, the boxes with numerals correspond to the units as illustrated in FIG. 1, FIG. 5 or the like and described in the specification.

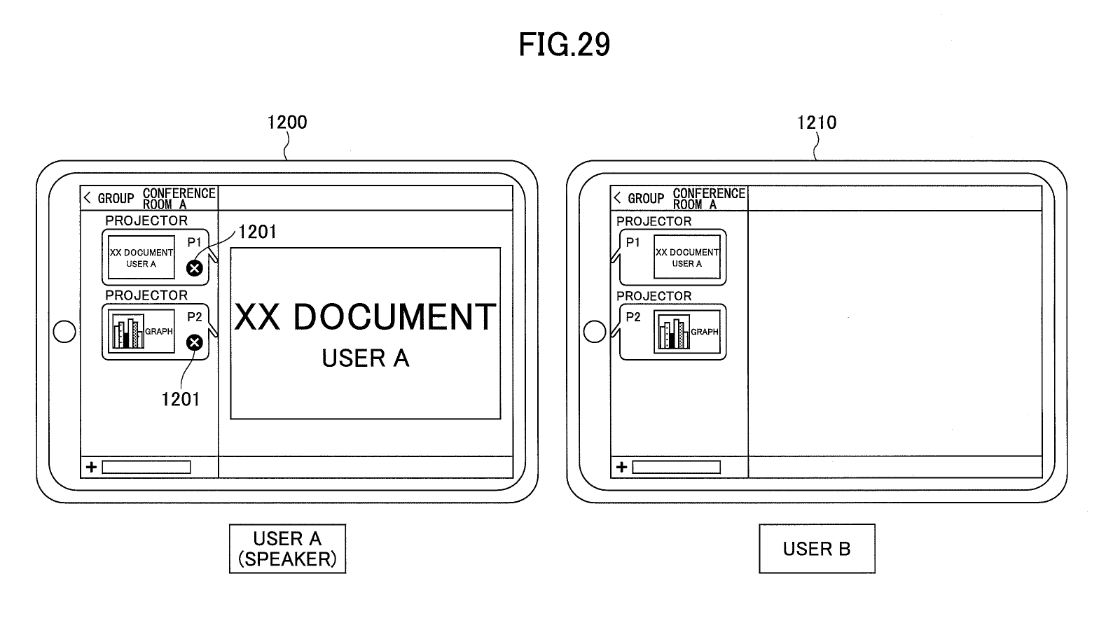

In step S211, the user A can prohibit an acquisition of a file by the user B or the like by pressing a prohibition of acquisition button 1201 in the conference status screen 1200 as illustrated in FIG. 29 displayed on the smart device 11A. Here, the prohibition of acquisition button 1201 is not displayed in the conference status screen 1210 that is displayed on the smart device 11B of the user B, for example, other than the user A.

In step S212, the smart device 11A requests the data processing apparatus 10 for setting the prohibition of acquisition by designating a file path and a page. In step S213, the Web API unit 31 and the Web control unit 32 of the data processing apparatus 10 request the IM agent unit 33 to set the prohibition of acquisition by designating the file path and the page.

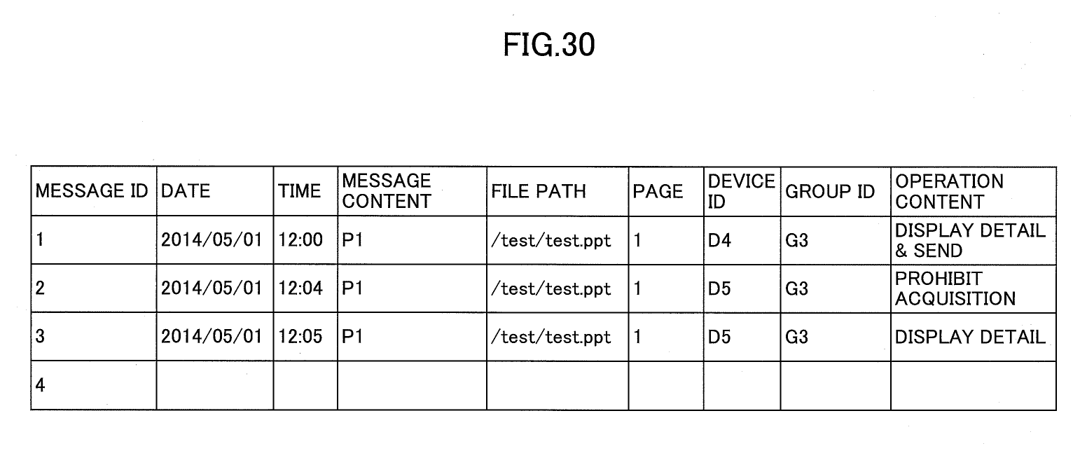

In step S214, the IM agent unit 33 stores a message history as illustrated in FIG. 30, for example. FIG. 30 is a view illustrating another example of a structure of a message history. The message history of FIG. 30 is different from the message history of FIG. 20 in that a record of prohibition of acquisition is added in the operation content.

Here, referring back to FIG. 28, a case is described in which the user B touches a message for which the prohibition of acquisition button 1201 is pressed by the user A in step S215. The smart device 11B requests the data processing apparatus 10 to obtain the file by designating the message ID of the message touched by the user B, in step S215.

In step S217, the Web API unit 31 and the Web control unit 32 of the data processing apparatus 10 store a history of touching the message by the user B in the message history of FIG. 30 as a record. As such, in the sequence diagram of FIG. 28, although the timing at which the record is added as the message history is different from that explained above with reference to FIG. 14, the record may be added at the timing when the device B is logged out from the conference room group as explained above with reference to FIG. 14.

As processes of steps S218 to 5219 are the same as those of steps S51 to S52 of FIG. 14, explanations are not repeated. Further, as processes of steps S220 to S222 are the same as those of steps S151 to S153 of FIG. 26, explanations are not repeated.

In step S223, the IM agent unit 33 removes the file path and the page number of the file for which acquisition is prohibited, from the path list converted in step S222 based on the record of “prohibition of acquisition” of the operation content of the message history of FIG. 30.

Then, in step S224, the IM agent unit 33 request the file management unit 36 to store the file by designating the path list.

In step S225, the file management unit 36 generates a folder accessible by the user B. In step S226, the file management unit 36 merges one or more files indicated by the path lists into a single file. Then, the file management unit 36 stores the merged file in the folder generated in step S225. The file management unit 36 returns the file path of the file stored in the folder to the IM agent unit 33. Processes thereafter are the same as the processes after step S157 of FIG. 26.

Thus, according to the sequence diagram of FIG. 28, as the file path and the page number for which the user A presses the prohibition of acquisition button 1201 are removed from the path list converted in step S222, it is easy to set a file that is cannot be obtained by other users such as the user B.

### (Summary)

As described above, according to the conference system 1 of the embodiment, a message including an image that becomes capable of being viewed by users participating in a conference during the conference is delivered and displayed on a time line screen of each of the users. By performing a selection operation such as touching or the like on the message on the time line screen for which the user wants to acquire the image after being logged out, each of the users can easily acquire a file in which the selected images are merged.

On the other hand, a user such as a speaker of the conference can easily select, among images that are capable of being viewed by other users during the conference, an image that can be provided to other users who participate in the conference and an image provision of which is prohibited, during the conference. Further, for the user such as the speaker of the conference, it is unnecessary to send the images that are viewed during the conference to other users who participate in the conference.

Thus, according to the conference system 1 of the embodiment, each of the users can select data, among data viewable to a plurality of users during the conference, necessary for the user after the conference, during the conference. Further, according to the conference system 1 of the embodiment, the data selected by each of the users during the conference are merged into a single file and the file is provided to each of the users.

According to the embodiments, a data processing system is provided by which data that is under a viewable state among a plurality of users can be easily provided after the viewable state is finished.

Although a preferred embodiment of the data processing system and the data processing method has been specifically illustrated and described, it is to be understood that minor modifications may be made therein without departing from the spirit and scope of the invention as defined by the claims.

A group data storing unit corresponds to a group list or a member list. A notification unit corresponds to the IM agent unit 33 of the data processing apparatus 10. A history data storing unit corresponds to the message history. A management unit corresponds to the file management unit 36. Here, the file is an example of electronic data.

The individual constituents of the conference system 1 may be embodied by arbitrary combinations of hardware and software, typified by a CPU of an arbitrary computer, a memory, a program loaded in the memory so as to embody the constituents illustrated in the drawings, a storage unit for storing the program such as a hard disk, and an interface for network connection. It may be understood by those skilled in the art that methods and devices for the embodiment allow various modifications.

The present invention is not limited to the specifically disclosed embodiments, and numerous variations and modifications may be made without departing from the spirit and scope of the present invention.

The present application is based on and claims the benefit of priority of Japanese Priority Application No. 2014-244734 filed on Dec. 3, 2014, the entire contents of which are hereby incorporated by reference.

What is claimed is:

1. A data processing system including at least a data processing apparatus, comprising:
a group data storing unit that stores a plurality of terminal devices and an electronic device that performs at least one of inputting and outputting of an image, as a group;
a notification unit that notifies data regarding an image that is input or output by the electronic device to the terminal devices that are in the same group as the electronic device while the data regarding the image is under a viewable state among the terminal devices;
a history data storing unit that stores, for each of the terminal devices, information of electronic data of the image in association with the data regarding the image selected at the respective terminal device among the data regarding the image notified to the terminal device; and
a management unit that provides, for each of the terminal devices, the electronic data of the image to the respective terminal device based on the information of the electronic data of the image stored in the history data storing unit in association with the data regarding the image selected at the respective terminal device after the viewable state is finished.

2. The data processing system according to claim 1,
wherein the management unit
generates, for each of the terminal devices, an electronic data storing unit accessible by the respective terminal device,
stores the electronic data of the image in the electronic data storing unit for each of the terminal devices, and
provides the electronic data of the image for each of the terminal devices.

3. The data processing system according to claim 1,
wherein the history data storing unit stores prohibition information of electronic data of the image in association with the data regarding the image selected as prohibiting acquisition among the data regarding the image notified to the terminal device,
wherein the management unit removes, for each of the terminal devices, the electronic data of the image that is selected as prohibiting acquisition from the electronic data of the image to be provided to the respective terminal device.

4. The data processing system according to claim 1,
wherein the notification unit notifies a message including the image that is input or output by the electronic device as the data regarding the image to the terminal devices that are in the same group as the electronic device.

5. A data processing system including a data processing apparatus and a plurality of terminal devices, comprising:
a group data storing unit that stores the terminal devices and the electronic device that performs at least one of inputting and outputting of an image, as a group;
a notification unit that notifies data regarding an image that is input or output by the electronic device to the terminal devices that are in the same group as the electronic device while the data regarding the image is under a viewable state among the terminal devices;
a display control unit that displays, for each of the terminal devices, the data regarding the image in a selectable manner from the respective user and accepts a selection of the data regarding the image;
a history data storing unit that stores, for each of the terminal devices, information of electronic data of the image in association with the data regarding the image selected at the respective terminal device among the data regarding the image notified to the terminal device; and
a management unit that provides, for each of the terminal devices, the electronic data of the image to the respective terminal device based on the information of the electronic data of the image stored in the history data storing unit in association with the data regarding the image selected at the respective terminal device after the viewable state is finished.

6. A data processing method performed by a data processing system including at least a data processing apparatus, comprising:
storing a plurality of terminal devices and an electronic device that performs at least one of inputting and outputting of an image, as a group;
notifying data regarding an image that is input or output by the electronic device to the terminal devices that are in the same group as the electronic device while the data regarding the image is under a viewable state among the terminal devices;
storing, for each of the terminal devices, information of electronic data of the image in association with the data regarding the image selected at the respective terminal device among the data regarding the image notified to the terminal device; and
providing, for each of the terminal devices, the electronic data of the image to the respective terminal device based on the information of the electronic data of the image stored in the storing the information of electronic data of the image in association with the data regarding the image selected at the respective terminal device after the viewable state is finished.
